(19) United States
(12) Patent Application Publication
(10) Pub. No.: US 2024/0032007 A1
(43) Pub. Date: Jan. 25, 2024

(54) TRANSMISSION METHOD AND APPARATUS, TERMINAL, AND NETWORK-SIDE DEVICE

(71) Applicant: VIVO MOBILE COMMUNICATION CO., LTD., Dongguan (CN)

(72) Inventors: Zhi LU, Dongguan (CN); Xueming PAN, Dongguan (CN); Na LI, Dongguan (CN)

(73) Assignee: VIVO MOBILE COMMUNICATION CO., LTD., Dongguan (CN)

(21) Appl. No.: 18/375,451

(22) Filed: Sep. 29, 2023

Related U.S. Application Data
(63) Continuation of application No. PCT/CN2022/085481, filed on Apr. 7, 2022.

(30) Foreign Application Priority Data
Apr. 7, 2021 (CN) 202110373209.2

(51) Int. Cl. H04W 72/0453; H04L 5/14

(52) U.S. Cl. CPC H04W 72/0453; H04L 5/14

(57) ABSTRACT

Transmission methods and a terminal are provided. An exemplary method includes: determining, by a terminal, locations of frequency domain resources in a Frequency Division Duplexing (FDD) pattern; and performing, by the terminal, transmission according to the locations of the frequency domain resources. The locations of the frequency domain resources include: a downlink frequency domain resource located at an edge in a band of a downlink Bandwidth Part (BWP) or a downlink carrier, and an uplink frequency domain resource or a flexible frequency domain resource located in at least part of a target area in the band of the downlink BWP or the downlink carrier.

### CROSS-REFERENCE TO RELATED APPLICATIONS

This application is a continuation of International Application No. PCT/CN2022/085481, filed on Apr. 7, 2022, which claims priority to Chinese Patent Application No. 202110373209.2, filed on Apr. 7, 2021. The entire contents of each of the above-referenced applications are expressly incorporated herein by reference.

### TECHNICAL FIELD

This application relates to the technical field of communications, and in particular, to a transmission method and apparatus, a terminal, and a network-side device.

### BACKGROUND

After a network configures a Bandwidth Part (BWP, also known as subset bandwidth) for a terminal, the BWP will use determined Uplink (UL) resources and Downlink (DL) resources, which will not change.

Usually, uplink and downlink services of the terminal are asymmetric. In some scenarios, the uplink traffic is greater than the downlink traffic. But in other scenarios, the downlink traffic is greater than the uplink traffic. For example, the downlink traffic of the whole system is large and the downlink resources are in shortage at some moments. But the utilization of the uplink resources is low and there are more idle resources. As a result, the utilization of system resources is inefficient.

### SUMMARY

Embodiments of this application provide a transmission method and apparatus, a terminal, and a network-side device.

According to a first aspect, a transmission method is provided. The method includes:

determining, by a terminal, locations of frequency domain resources in a Frequency Division Duplexing (FDD) pattern; and

performing, by the terminal, transmission according to the locations of the frequency domain resources.

The locations of the frequency domain resources include any one of the following:

a downlink frequency domain resource is located at an edge in a band of a downlink BWP or a downlink carrier, and an uplink frequency domain resource and/or a flexible frequency domain resource are/is located in at least part of a target area in the band of the downlink BWP or the downlink carrier; or

an uplink frequency domain resource is located at an edge in a band of an uplink BWP or an uplink carrier, and a downlink frequency domain resource and/or a flexible frequency domain resource are/is located in at least part of a target area in the band of the uplink BWP or the uplink carrier.

The target area is an area other than the edge in the band.

According to a second aspect, a transmission method is provided. The method includes:

determining, by a network-side device, locations of frequency domain resources in an FDD pattern; and

performing, by the network-side device, transmission based on the locations of the frequency domain resources.

The locations of the frequency domain resources include any one of the following:

a downlink frequency domain resource is located at an edge in a band of a downlink BWP or a downlink carrier, and an uplink frequency domain resource and/or a flexible frequency domain resource are/is located in at least part of a target area in the band of the downlink BWP or the downlink carrier; or

an uplink frequency domain resource is located at an edge in a band of an uplink BWP or an uplink carrier, and a downlink frequency domain resource and/or a flexible frequency domain resource are/is located in at least part of a target area in the band of the uplink BWP or the uplink carrier.

The target area is an area other than the edge in the band.

According to a third aspect, a transmission method is provided. The method includes:

determining, by a terminal, locations of frequency domain resources in a Time Division Duplexing (TDD) pattern, and

performing, by the terminal, transmission according to the locations of the frequency domain resources.

The locations of the frequency domain resources include any one of the following:

a downlink frequency domain resource is located at an edge in a band of a BWP or a carrier corresponding to a downlink slot, and an uplink frequency domain resource and/or a flexible frequency domain resource are/is located in at least part of a target area in the band of the BWP or the carrier corresponding to the downlink slot, or

an uplink frequency domain resource is located at an edge in a band of a BWP or a carrier corresponding to an uplink slot, and a downlink frequency domain resource and/or a flexible frequency domain resource are/is located in at least part of a target area in the band of the BWP or the carrier corresponding to the uplink slot.

The target area is an area other than the edge in the band.

According to a fourth aspect, a transmission method is provided. The method includes:

determining, by a network-side device, locations of frequency domain resources in a TDD pattern; and

performing, by the network-side device, transmission according to the locations of the frequency domain resources.

The locations of the frequency domain resources include any one of the following:

a downlink frequency domain resource is located at an edge in a band of a BWP or a carrier corresponding to a downlink slot, and an uplink frequency domain resource and/or a flexible frequency domain resource are/is located in at least part of a target area in the band of the BWP or the carrier corresponding to the downlink slot; or

an uplink frequency domain resource is located at an edge in a band of a BWP or a carrier corresponding to an uplink slot, and a downlink frequency domain resource and/or a flexible frequency domain resource are/is located in at least part of a target area in the band of the BWP or the carrier corresponding to the uplink slot.

The target area is an area other than the edge in the band.

According to a fifth aspect, a transmission apparatus is provided. The apparatus is applied to a terminal, and includes:

a determination module, configured to determine deployment locations of frequency domain resources in a FDD pattern; and

a transmission module, configured to perform transmission according to the deployment locations of the frequency domain resources.

The deployment locations of the frequency domain resources include any one of the following:

a downlink frequency domain resource is deployed at an edge in a band of a downlink BWP or a downlink carrier, and an uplink frequency domain resource and/or a flexible frequency domain resource are/is deployed in at least part of a target area in the band of the downlink BWP or the downlink carrier; or

an uplink frequency domain resource is deployed at an edge in a band of an uplink BWP or an uplink carrier, and a downlink frequency domain resource and/or a flexible frequency domain resource are/is deployed in at least part of a target area in the band of the uplink BWP or the uplink carrier.

The target area is an area other than the edge in the band.

According to a sixth aspect, a transmission apparatus is provided. The apparatus is applied to a network-side device, and includes:

a determination module, configured to determine deployment locations of frequency domain resources in a FDD pattern; and

a transmission module, configured to perform transmission based on the deployment locations of the frequency domain resources.

The deployment locations of the frequency domain resources include any one of the following:

a downlink frequency domain resource is deployed at an edge in a band of a downlink BWP or a downlink carrier, and an uplink frequency domain resource and/or a flexible frequency domain resource are/is deployed in at least part of a target area in the band of the downlink BWP or the downlink carrier; or

an uplink frequency domain resource is deployed at an edge in a band of an uplink BWP or an uplink carrier, and a downlink frequency domain resource and/or a flexible frequency domain resource are/is deployed in at least part of a target area in the band of the uplink BWP or the uplink carrier.

The target area is an area other than the edge in the band.

According to a seventh aspect, a transmission apparatus is provided. The apparatus is applied to a terminal, and includes:

a determination module, configured to determine deployment locations of frequency domain resources in a TDD pattern, and

a transmission module, configured to perform transmission according to the deployment locations of the frequency domain resources.

The deployment locations of the frequency domain resources include any one of the following:

a downlink frequency domain resource is deployed at an edge in a band of a BWP or a carrier corresponding to a downlink slot, and an uplink frequency domain resource and/or a flexible frequency domain resource are/is deployed in at least part of a target area in the band of the BWP or the carrier corresponding to the downlink slot; or

an uplink frequency domain resource is deployed at an edge in a band of a BWP or a carrier corresponding to an uplink slot, and a downlink frequency domain resource and/or a flexible frequency domain resource are/is deployed in at least part of a target area in the band of the BWP or the carrier corresponding to the uplink slot.

The target area is an area other than the edge in the band.

According to an eighth aspect, a transmission apparatus is provided. The apparatus is applied to a network-side device, and includes:

a determination module, configured to determine deployment locations of frequency domain resources in a TDD pattern; and

a transmission module, configured to perform transmission according to the deployment locations of the frequency domain resources.

The deployment locations of the frequency domain resources include any one of the following:

a downlink frequency domain resource is deployed at an edge in a band of a BWP or a carrier corresponding to a downlink slot, and an uplink frequency domain resource and/or a flexible frequency domain resource are/is deployed in at least part of a target area in the band of the BWP or the carrier corresponding to the downlink slot; or

an uplink frequency domain resource is deployed at an edge in a band of a BWP or a carrier corresponding to an uplink slot, and a downlink frequency domain resource and/or a flexible frequency domain resource are/is deployed in at least part of a target area in the band of the BWP or the carrier corresponding to the uplink slot.

The target area is an area other than the edge in the band.

According to a ninth aspect, a terminal is provided. The terminal includes a processor, a memory, and programs or instructions stored in the memory and executable on the processor. The programs or instructions, when executed by the processor, implement steps of the method as described in the first aspect or implement steps of the method as described in the third aspect.

According to a tenth aspect, a network-side device is provided. The network-side device includes a processor, a memory, and programs or instructions stored in the memory and executable on the processor. The programs or instructions, when executed by the processor, implement steps of the method as described in the second aspect or implement steps of the method as described in the fourth aspect.

According to an eleventh aspect, a readable storage medium is provided. The readable storage medium stores programs or instructions. The programs or instructions, when executed by a processor, implement steps of the method as described in the first aspect, implement steps of the method as described in the second aspect, implement steps of the method as described in the third aspect, or implement steps of the method as described in the fourth aspect.

According to a twelfth aspect, a chip is provided. The chip includes a processor and a communication interface. The communication interface is coupled to the processor. The processor is configured to execute programs or instructions to implement steps of the method as described in the first aspect, implement steps of the method as described in the second aspect, implement steps of the method as described in the third aspect, or implement steps of the method as described in the fourth aspect.

According to a thirteenth aspect, a computer program/program product is provided. The computer program/program product is stored in a non-transient storage medium. The program/program product is executed by at least one processor to implement steps of the method as described in the first aspect, implement steps of the method as described in the second aspect, implement steps of the method as described in the third aspect, or implement steps of the method as described in the fourth aspect.

According to the transmission method and apparatus, the terminal, and the network-side device provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

### BRIEF DESCRIPTION OF THE DRAWINGS

FIG. 1 is a block diagram of a wireless communication system according to some embodiments of this application.

FIG. 2 is a schematic diagram of a network-side device configuring a BWP for a terminal according to some embodiments of this application.

FIG. 3 is a schematic flowchart 1 of a transmission method according to an embodiment of this application.

FIG. 4 is a schematic diagram 1 of a network-side device deploying frequency domain resources according to an embodiment of this application.

FIG. 5 is a schematic diagram 2 of a network-side device deploying frequency domain resources according to an embodiment of this application.

FIG. 6 is a schematic diagram 3 of a network-side device deploying frequency domain resources according to an embodiment of this application.

FIG. 7 is a schematic diagram 4 of a network-side device deploying frequency domain resources according to an embodiment of this application.

FIG. 8 is a schematic diagram 5 of a network-side device deploying frequency domain resources according to an embodiment of this application.

FIG. 9 is a schematic diagram 6 of a network-side device deploying frequency domain resources according to an embodiment of this application.

FIG. 10 is a schematic flowchart 2 of a transmission method according to an embodiment of this application.

FIG. 11 is a schematic flowchart 3 of a transmission method according to an embodiment of this application.

FIG. 12 is a schematic diagram of deployment of frequency domain resources in the related art.

FIG. 13 is a schematic diagram 7 of a network-side device deploying frequency domain resources according to an embodiment of this application.

FIG. 14 is a schematic diagram 8 of a network-side device deploying frequency domain resources according to an embodiment of this application.

FIG. 15 is a schematic diagram 9 of a network-side device deploying frequency domain resources according to an embodiment of this application.

FIG. 16 is a schematic diagram 10 of a network-side device deploying frequency domain resources according to an embodiment of this application.

FIG. 17 is a schematic flowchart 4 of a transmission method according to an embodiment of this application.

FIG. 18 is a schematic structural diagram 1 of a transmission apparatus according to an embodiment of this application.

FIG. 19 is a schematic structural diagram 2 of a transmission apparatus according to an embodiment of this application.

FIG. 20 is a schematic structural diagram 3 of a transmission apparatus according to an embodiment of this application.

FIG. 21 is a schematic structural diagram 4 of a transmission apparatus according to an embodiment of this application.

FIG. 22 is a schematic diagram of a hardware structure of a terminal according to an embodiment of this application.

FIG. 23 is a schematic structural diagram of a communication device according to an embodiment of this application.

FIG. 24 is a schematic diagram of a hardware structure of a network-side device according to an embodiment of this application.

### DETAILED DESCRIPTION

The technical solutions in embodiments of this application are clearly described in the following with reference to the accompanying drawings in the embodiments of this application. Apparently, the described embodiments are merely some rather than all of the embodiments of this application. All other embodiments obtained by a person skilled in the art based on the embodiments of this application fall within the protection scope of this application.

The terms “first” and “second” in the specification and claims of this application are used to distinguish similar objects, but are unnecessarily used to describe a specific sequence or order. It is to be understood that the terms used in this way are exchangeable in a proper case, so that the embodiments of this application described herein can be implemented in an order different from the order shown or described herein. The objects distinguished by “first” and “second” are generally in one class, and the number of objects is not limited. For example, there may be one or more first objects. In addition, “and/or” in the specification and claims represents at least one of the connected objects, and the character “/” generally represents that the associated objects are in an “or” relation.

It is to be noted that the technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), orthOrthogonal Frequency Division Multiple Access (OFDMA), Single-Carrier Frequency-Division Multiple Access (SC-FDMA), and other systems. The terms “system” and “network” in the embodiments of this application are often used interchangeably. The technology described may be applied to the systems and radio technologies mentioned above, and may also be applied to other systems and radio technologies. The following description describes a New Radio (NR) system for example purposes and uses the NR term in most of the following descriptions, but these technologies may also be applied to applications other than NR system applications, such as 6th Generation (60) communication systems.

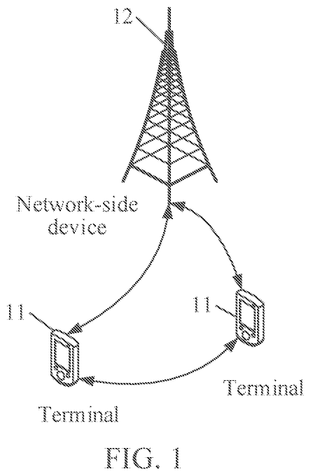

FIG. 1 shows a block diagram of a wireless communication system according to some embodiments of this application. The wireless communication system includes a terminal 11 and a network-side device 12. The terminal 11 may also be referred to as a terminal device or User Equipment (UE). The terminal 11 may be a terminal-side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (home device with a wireless communication function, such as a refrigerator, a television, a laundry machine or furniture), a game machine, a Personal Computer (PC), a teller machine or a self-service machine. The wearable device includes: smart watches, smart bands, smart headphones, smart glasses, smart jewelry (smart bracelets, smart chain bracelets, smart rings, smart necklaces, smart anklets, and smart chain anklets), smart wristbands, smart clothing, and the like. It is to be noted that the specific type of the terminal 11 is not limited in the embodiments of this application. The network-side device 12 may include an access network device or a core network device. The access network device may also be referred to as a radio access network device, a Radio Access Network (RAN), a radio access network function, or a radio access network unit. The network-side device 12 may include a base station, a WLAN access point, or a WiFi node. The base station may be referred to as a node B, an evolved Node B (eNB), an access point, a Base Transceiver Station (BTS), a radio base station, a radio transceiver, a Basic Service Set (BSS), an Extended Service Set (ESS), a home node B, a home evolved node B, a WLAN access point, a WiFi node, a Transmission and Reception Point (TRP), or some other suitable term in the art. The base station is not limited to a particular technical vocabulary as long as the same technical effect is achieved. It is to be noted that only a base station in an NR system is used as an example in the embodiments of this application, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized Network Configuration (CNC), a Network Repository Function (NRF), a Network Exposure Function (NEF), a Local NEF (L-NEF), a Binding Support Function (BSF), an Application Function (AF), and the like. It is to be noted that only a core network device in an NR system is used as an example in the embodiments of this application, but a specific type of the core network device is not limited.

In order to more fully understand the technical solution provided by the embodiments of this application, the following contents are introduced:

Compared with conventional mobile communications systems, 5G mobile communications systems in the future need to adapt to more diversified scenarios and service requirements. The main scenarios of 5G include eMBB, URLLC, mMTC, and the like. These scenarios require the systems with high reliability, low latency, large bandwidth, and wide coverage.

In the NR, the network-side device configures a BWP and/or a carrier for the terminal to transmit data. The bandwidth of the terminal may be dynamically changed.

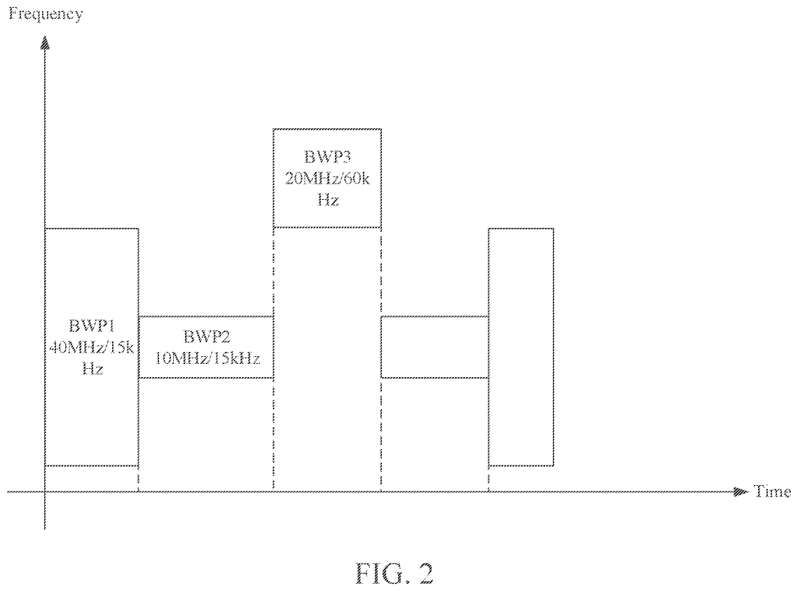

Details are shown in FIG. 2. At a first moment, the terminal traffic is large, and the system configures a large bandwidth (BWP1) for the terminal. At a second moment, the terminal traffic is small, and the system configures a small bandwidth (BWP2) for the terminal to meet basic communication requirements. At a third moment, the system finds that there is a wide range of frequency selective fading within a bandwidth where BWP1 is located, or resources are in shortage within a frequency range where BWP1 is located. Therefore, a new bandwidth (BWP3) is configured for UE.

Each BWP is not only different in frequency point and bandwidth, but also may correspond to different configurations. For example, a subcarrier spacing, CP type, and PSS/SSS PBCH Block period of each BWP may be configured differently to adapt to different services.

There are four main technical advantages of the BWP:
1. The terminal only needs to meet a minimum bandwidth requirement without supporting all bandwidths.
2. When the terminal traffic is not large, the terminal may switch a narrow bandwidth and operate, that can obviously reduce the power consumption.
3. The 5G technology is forward compatible. When 5G is added with a new technology, the new technology may be directly operated on a new BWP, thereby ensuring the forward compatibility of the system.
4. The BWP is dynamically configured for the services to meet service requirements.

A frequency domain resource deployment method and apparatus and a network-side device provided by the embodiments of this application will be described in detail with reference to the accompanying drawings through some embodiments and application scenarios thereof.

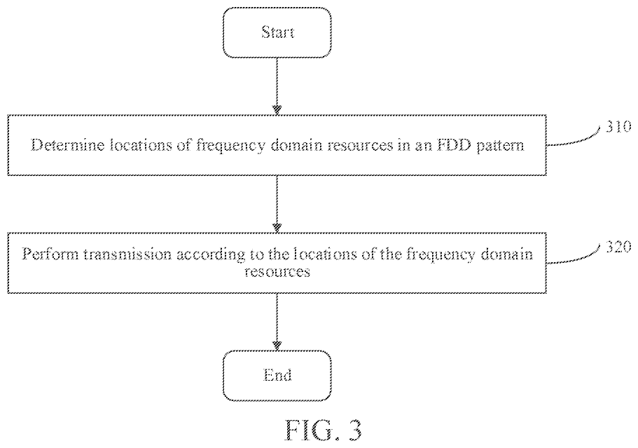

FIG. 3 is a schematic flowchart 1 of a transmission method according to an embodiment of this application. Referring to FIG. 3, the embodiments of this application provide a transmission method, which may include the following steps:

Step 310: Determine locations of frequency domain resources in an FDD pattern.

Step 320: Perform transmission according to the locations of the frequency domain resources.

The locations of the frequency domain resources include any one of the following:

a downlink frequency domain resource is located at an edge in a band of a downlink BWP or a downlink carrier, and an uplink frequency domain resource and/or a flexible frequency domain resource are/is located in at least part of a target area in the band of the downlink BWP or the downlink carrier; or

an uplink frequency domain resource is located at an edge in a band of an uplink BWP or an uplink carrier, and a downlink frequency domain resource and/or a flexible frequency domain resource are/is located in at least part of a target area in the band of the uplink BWP or the uplink carrier.

The target area is an area other than the edge in the band.

It is to be noted that the executive entity of the transmission method provided by the embodiments of this application may be a terminal, such as a mobile phone or a computer. The technical solution of this application is described in detail based on an example where the transmission method provided by the embodiments of this application is performed by the terminal.

The terminal may determine locations of frequency domain resources prior to transmission (for example, uplink transmission).

After determining the locations of the frequency domain resources, the terminal may perform corresponding transmission according to the locations of the frequency domain resources. For example, the terminal may perform uplink transmission at an uplink frequency domain resource after confirming a location of the uplink frequency domain resource.

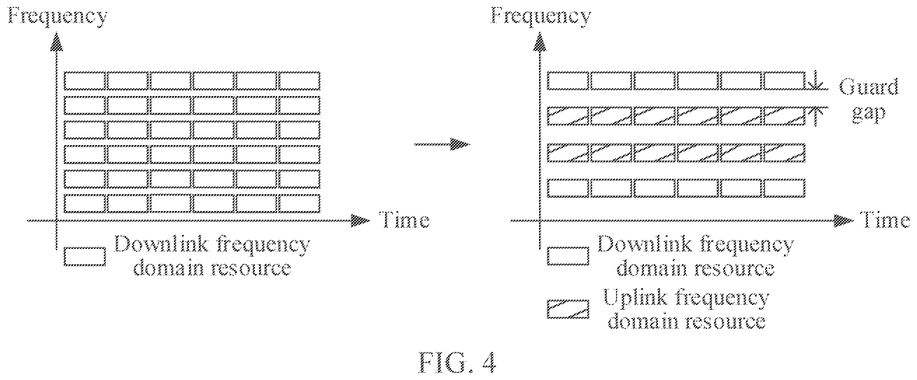

As shown in FIG. 4, a left spectrum diagram shows the deployment of a downlink frequency domain resource by a network-side device in the related art. That is, the downlink frequency domain resource is located in the whole downlink BWP or downlink carrier.

A right spectrum diagram in FIG. 4 shows the locations of frequency domain resources in a transmission method provided by the embodiments of this application: a downlink frequency domain resource is located at an edge in a band of a downlink BWP or a downlink carrier, and an uplink frequency domain resource and/or a flexible frequency domain resource are/is located in at least part of a target area in the band of the downlink BWP or the downlink carrier.

It is to be noted that for example, an edge in a band of a certain downlink BWP or downlink carrier of 600-619 MHz may correspond to a predefined bandwidth, such as 600-601 MHz and 618-619 MHz. In the related art, for channel bandwidth, the edge in the band is usually defined as an integer multiple of Resource Block (RB) or a guard gap.

In the embodiments of this application, the network-side device may deploy the downlink frequency domain resource at the edge in the band of the downlink BWP or the downlink carrier. For example, in a case that the edge in the band of the downlink BWP or the downlink carrier corresponds to 110 RBs, the network-side device may deploy a part of the 110 RBs, for example, 100 RBs, as the downlink frequency domain resource, and deploy the remaining 5 RBs at the outermost ends of the band (for example, RBs corresponding to 600-600.9 MHz and 618.1-619 MHz) as the guard gap.

It is to be noted that the flexible frequency domain resource refers to the frequency domain resource can be used as the uplink frequency domain resource, or used as the downlink frequency domain resource

The network-side device may also deploy the uplink frequency domain resource and/or the flexible frequency domain resource in at least part of the target area in the band of the downlink BWP or the downlink carrier. As shown in the right spectrum diagram in FIG. 4, the uplink frequency domain resource (the flexible frequency domain resource may be used as the uplink frequency domain resource) is located anywhere in the downlink BWP or the downlink carrier except at the edge in the band.

The downlink frequency domain resource may also be located in the remaining target area in a case that the uplink frequency domain resource and/or the flexible frequency domain resource are/is located in at least part of the target area in the band of the downlink BWP or the downlink carrier.

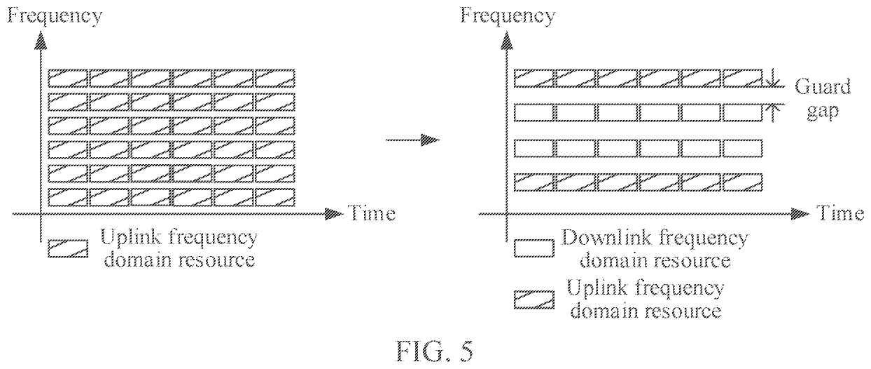

As shown in FIG. 5, a left spectrum diagram shows the deployment of an uplink frequency domain resource by a network-side device in the related art. That is, the uplink frequency domain resource is located in the whole uplink BWP or uplink carrier.

A right spectrum diagram in FIG. 5 shows the locations of frequency domain resources in a transmission method provided by the embodiments of this application: an uplink frequency domain resource is located at an edge in a band of an uplink BWP or an uplink carrier, and a downlink frequency domain resource and/or a flexible frequency domain resource are/is located in at least part of a target area in the band of the uplink BWP or the uplink carrier.

It is to be noted that for example, an edge in a band of a certain uplink BWP or uplink carrier of 600-619 MHz may be, for example, 600-601 MHz and 618-619 MHz, correspondingly. In the related art, the edge in the band is usually defined as an integer multiple of RB or a guard gap.

In the embodiments of this application, the network-side device may deploy the uplink frequency domain resource at the edge in the band of the uplink BWP or the uplink carrier. For example, in a case that the edge in the band of the uplink BWP or the uplink carrier corresponds to 110 RBs, the network-side device may deploy a part of the 110 RBs, for example, 100 RBs, as the uplink frequency domain resource, and deploy the remaining 5 RBs at the outermost ends of the band (for example, RBs corresponding to 600-600.9 MHz and 618.1-619 MHz, and assuming a subcarrier spacing of 15 kHz) as the guard gap.

The network-side device may also deploy the downlink frequency domain resource and/or the flexible frequency domain resource in at least part of the target area in the band of the uplink BWP or the uplink carrier. As shown in the right spectrum diagram in FIG. 5, the downlink frequency domain resource (the flexible frequency domain resource may be used as the downlink frequency domain resource) is located anywhere in the uplink BWP or the uplink carrier except at the edge in the band.

The uplink frequency domain resource may also be located in the remaining target area in a case that the downlink frequency domain resource and/or the flexible frequency domain resource are/is located in at least part of the target area in the band of the uplink BWP or the uplink carrier.

According to the transmission method provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In the network-side device, the guard gaps are arranged between the downlink frequency domain resource and the uplink frequency domain resource, between the downlink frequency domain resource and the flexible frequency domain resource, between the uplink frequency domain resource and the flexible frequency domain resource, and between the flexible frequency domain resources, as shown in FIG. 4 and FIG. 5, so as to ensure that the downlink frequency domain resource, the uplink frequency domain resource, and the flexible frequency domain resource are not interfered with each other, thereby ensuring the smooth progress of communication.

In one embodiment, a frequency domain resource supporting flexible duplexiog is configured as the flexible frequency domain resource.

The network-side device may configure the frequency domain resource supporting flexible duplexing as the flexible frequency domain resource.

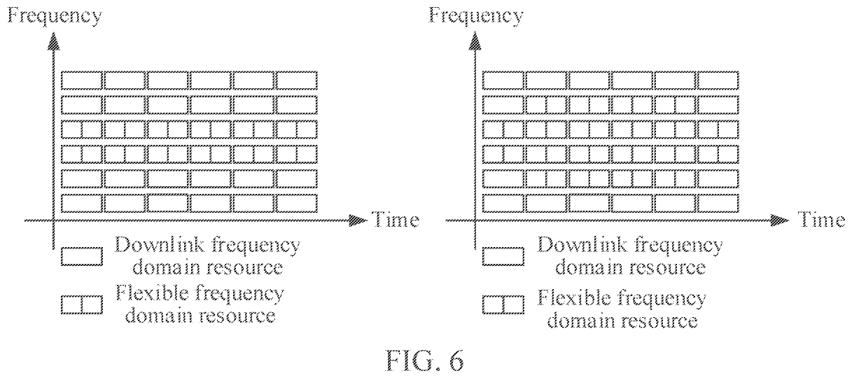

As shown in FIG. 6, the network-side device may configure the frequency domain resource supporting flexible duplexing as the flexible frequency domain resource in a case that the downlink frequency domain resource is located at the edge in the band of the downlink BWP or the downlink carrier. It is to be noted that FIG. 6 only shows two examples where the network-side device configures the frequency domain resource supporting flexible duplexing as the flexible frequency domain resource for the downlink BWP or the downlink carrier. On the basis of the embodiments of the present application, there may be various ways to configure the frequency domain resource supporting flexible duplexing as the flexible frequency domain resource, which are not exemplified one by one in this specification.

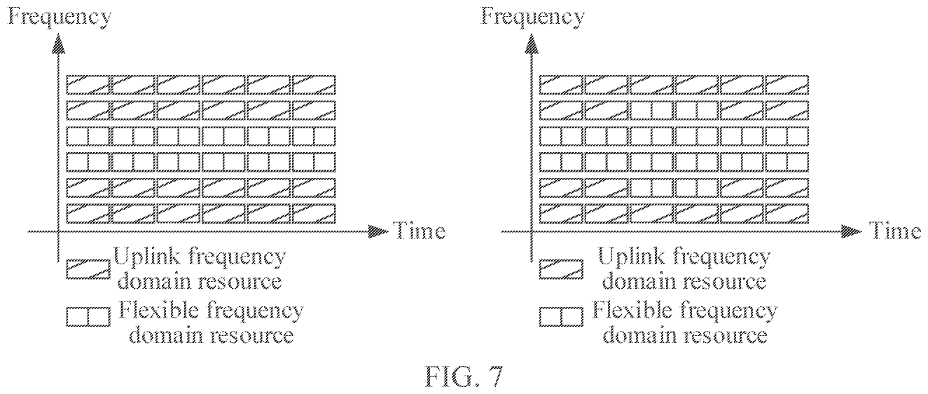

As shown in FIG. 7, the network-side device may configure the frequency domain resource supporting flexible duplexing as the flexible frequency domain resource in a case that the uplink frequency domain resource is located at the edge in the band of the uplink BWP or the uplink carrier. It is to be noted that FIG. 7 only shows two examples where the network-side device configures the frequency domain resource supporting flexible duplexing as the flexible frequency domain resource for the uplink BWP or the uplink carrier. On the basis of the embodiments of the present application, there may be various ways to configure the frequency domain resource supporting flexible duplexing as the flexible frequency domain resource, which are not exemplified one by one in this specification.

In one embodiment, the locations of the frequency domain resources may further include at least one of the following:

the downlink frequency domain resource is configured with a control resource set CORESET; or

the flexible frequency domain resource is configured with a CORESET in a case that the flexible frequency domain resource is used as the downlink frequency domain resource.

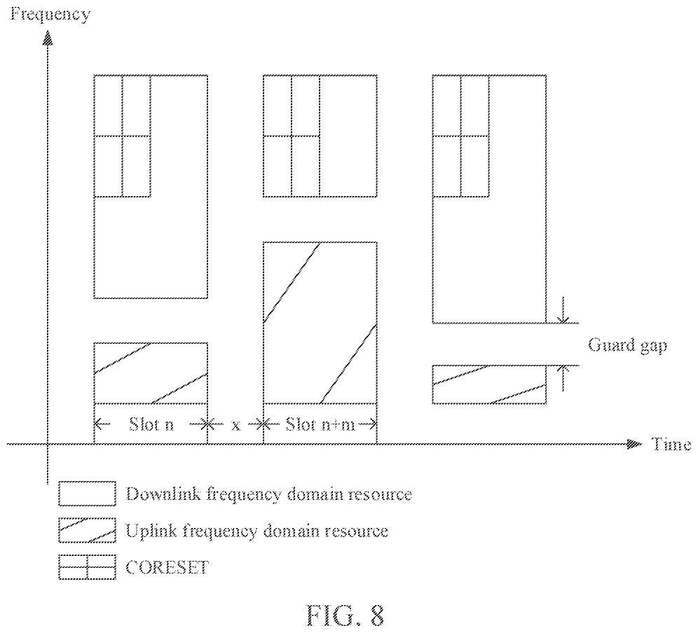

As shown in FIG. 8, the network-side device may configure the CORESET on the downlink frequency domain resource located at the edge in the band of the downlink BWP or the downlink carrier, or on the downlink frequency domain resource located in the target area, or on the downlink frequency domain resource originally used as the flexible frequency domain resource, or on a combination of the above frequency domain resources.

In order to reduce the influence on the CORESET configuration of a backward terminal, the network-side device may configure a full duplexing bandwidth and Time-Division Multiplexing (TDM) of a symbol where the CORESET is located.

It is to be understood that by configuring the CORESET on some downlink frequency domain resource, it may be ensured that the terminal will not be unable to use an effective CORESET when the downlink BWP or the downlink carrier is used for uplink services, thus affecting the normal communication.

It is to be noted that when a BWP is changed to time units (for example, slot n and slot n+m in FIG. 8) of different frequency domain uplink and downlink patterns, the network-side device will set a conversion time interval of x (x≤x is a positive integer) symbols between the two time units, or set a conversion time interval of at least one slot (m≥1, m is a positive integer).

In one embodiment, the operation of determining locations of frequency domain resources may further include:

determining a location of the uplink frequency domain resource or the downlink frequency domain resource or the flexible frequency domain resource in a half-duplexing pattern.

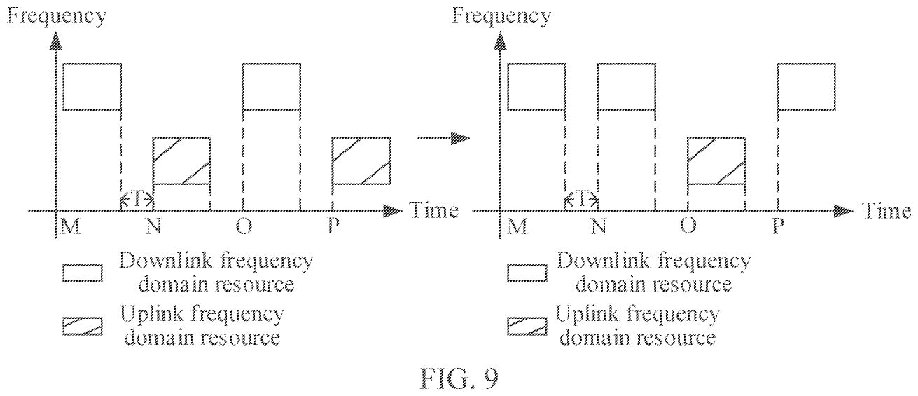

As shown in FIG. 9, a left spectrum diagram shows that the network-side device will instruct the terminal to use the uplink frequency domain resource or the downlink frequency domain resource at every time (conversion time is T) in a half-duplexing pattern in the related art. For example, the downlink frequency domain resource is used at time M, the uplink frequency domain resource is used at time N, the downlink resource is used at time O), and the uplink frequency domain resource is used at time P. A transmission direction at every time is determined, and the downlink frequency domain resource and the uplink frequency domain resource cannot change the transmission direction.

In the transmission method provided by the embodiments of this application, the network-side device may configure and instruct the terminal to use the uplink frequency domain resource, the downlink frequency domain resource, or the flexible frequency domain resource (used as the uplink frequency domain resource or the downlink frequency domain resource) according to the service requirements.

As shown in FIG. 9, a right spectrum diagram shows the locations of frequency domain resources in the half-duplexing pattern in the embodiments of this application: there may be the uplink frequency domain resource or the downlink frequency domain resource at every time.

For example, there may be the downlink frequency domain resource at time M, the downlink frequency domain resource at time N, the uplink frequency domain resource at time O, and the downlink frequency domain resource at time P. The transmission direction at every time may be notified by the network, and the corresponding downlink frequency domain resource and uplink frequency domain resource at every time may change the transmission direction.

As can be seen from the right spectrum diagram of FIG. 9, in the transmission method provided by the embodiments of this application, the uplink frequency domain resource, the downlink frequency domain resource, and the flexible frequency domain resource may be flexibly used according to actual service requirements, thereby improving the utilization of the frequency domain resources in the half-duplexing pattern.

In one embodiment, the transmission method provided by the embodiments of this application may further include:

stopping using the flexible frequency domain resource as the uplink frequency domain resource in a case that the flexible frequency domain resource satisfies a predetermined condition

The Predetermined Condition Includes:

the flexible frequency domain resource includes an SSB or CORESRT 0.

When a full duplexing downlink frequency domain resource is used as the uplink frequency domain resource, the influence on synch-raster/SSB/Coreset 0 shall be avoided.

Therefore, in the embodiments of this application, when there is a Synchronization Signal Block (SSB)/Coreset 0 on a flexible frequency resource or a DL frequency resource, the terminal will avoid using the flexible frequency domain resource or the downlink frequency domain resource as the uplink frequency domain resource to avoid affecting backward UE.

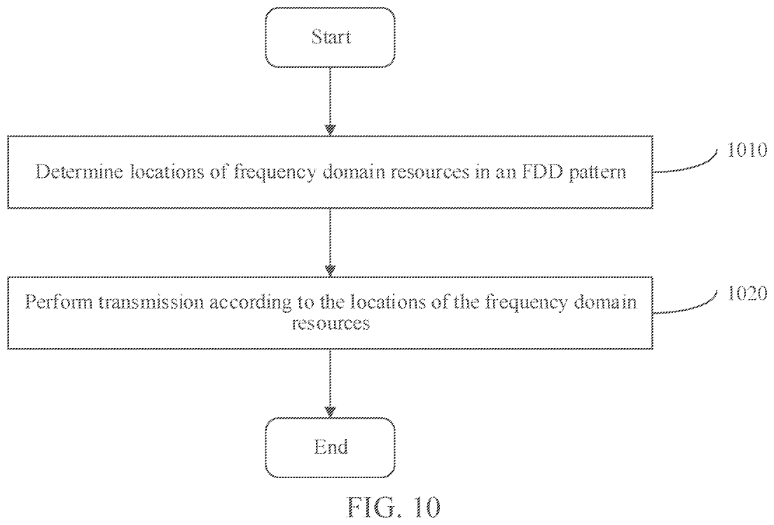

FIG. 10 is a schematic flowchart 2 of a transmission method according to an embodiment of this application. Referring to FIG. 10, the embodiments of this application provide a transmission method, which may include the following steps:

Step 1010: Determine locations of frequency domain resources in an FDD pattern.

Step 1020: Perform transmission according to the locations of the frequency domain resources.

The locations of the frequency domain resources include any one of the following.

a downlink frequency domain resource is located at an edge in a band of a downlink BWP or a downlink carrier, and an uplink frequency domain resource and/or a flexible frequency domain resource are/is located in at least part of a target area in the band of the downlink BWP or the downlink carrier; or

an uplink frequency domain resource is located at an edge in a band of an uplink BWP or an uplink carrier, and a downlink frequency domain resource and/or a flexible frequency domain resource are/is located in at least part of a target area in the band of the uplink BWP or the uplink carrier.

The target area is an area other than the edge in the band.

It is to be noted that the executive entity of the transmission method provided by the embodiments of this application may be a network-side device, such as a base station or a core network. The technical solution of this application is described in detail based on an example where the transmission method provided by the embodiments of this application is performed by the network-side device.

The network-side device may determine locations of frequency domain resources prior to transmission (for example, downlink transmission).

After determining the locations of the frequency domain resources, the network-side device may perform corresponding transmission according to the locations of the frequency domain resources. For example, the network-side device may perform downlink transmission at a downlink frequency domain resource after confirming a location of the downlink frequency domain resource.

As shown in FIG. 4, a left spectrum diagram shows the deployment of a downlink frequency domain resource by a network-side device in the related art. That is, the downlink frequency domain resource is located in the whole downlink BWP or downlink carrier.

A right spectrum diagram of FIG. 4 shows the locations of frequency domain resources in a transmission method provided by the embodiments of this application: a downlink frequency domain resource is located at an edge in a band of a downlink BWP or a downlink carrier, and an uplink frequency domain resource and/or a flexible frequency domain resource are/is located in at least part of a target area in the band of the downlink BWP or the downlink carrier.

It is to be noted that for example, an edge in a band of a certain downlink BWP or downlink carrier of 600-619 MHz may correspond to a predefined bandwidth, such as 600-601 MHz and 618-619 MHz. In the related art, for channel bandwidth, the edge in the band is usually defined as an integer multiple of RB or a guard gap.

In the embodiments of this application, the network-side device may deploy the downlink frequency domain resource at the edge in the band of the downlink BWP or the downlink carrier. For example, in a case that the edge in the band of the downlink BWP or the downlink carrier corresponds to 110 RBs, the network-side device may deploy a part of the 110 RBs, for example, 100 RBs, as the downlink frequency domain resource, and deploy the remaining 5 RBs at the outermost ends of the band (for example, RBs corresponding to 600-600.9 MHz and 618.1-619 MHz, and assuming a subcarrier spacing of 15 kHz) as the guard gap.

It is to be noted that the flexible frequency domain resource refers to the frequency domain resource used as both the uplink frequency domain resource and the downlink frequency domain resource.

The network-side device may also deploy the uplink frequency domain resource and/or the flexible frequency domain resource in at least part of the target area in the band of the downlink BWP or the downlink carrier. As shown in the right spectrum diagram in FIG. 4, the uplink frequency domain resource (the flexible frequency domain resource may be used as the uplink frequency domain resource) is located anywhere in the downlink BWP or the downlink carrier except at the edge in the band.

The downlink frequency domain resource may also be located in the remaining target area in a case that the uplink frequency domain resource and/or the flexible frequency domain resource are/is located in at least part of the target area in the band of the downlink BWP or the downlink carrier.

As shown in FIG. 5, a left spectrum diagram shows the deployment of an uplink frequency domain resource by a network-side device in the related art. That is, the uplink frequency domain resource is located in the whole uplink BWP or uplink carrier.

A right spectrum diagram of FIG. 5 shows the locations of frequency domain resources in a transmission method provided by the embodiments of this application: an uplink frequency domain resource is located at an edge in a band of an uplink BWP or an uplink carrier, and a downlink frequency domain resource and/or a flexible frequency domain resource are/is located in at least part of a target area in the band of the uplink BWP or the uplink carrier.

It is to be noted that for example, an edge in a band of a certain uplink BWP or uplink carrier of 600-619 MHz may be, for example, 600-601 MHz and 618-619 MHz, correspondingly. In the related art, the edge in the band is usually defined as an integer multiple of RB or a guard gap.

In the embodiments of this application, the network-side device may deploy the uplink frequency domain resource at the edge in the band of the uplink BWP or the uplink carrier. For example, in a case that the edge in the band of the uplink BWP or the uplink carrier corresponds to 110 RBs, the network-side device may deploy a part of the 110 RBs, for example, 100 RBs, as the uplink frequency domain resource, and deploy the remaining 5 RBs at the outermost ends of the band (for example, RBs corresponding to 600-600.9 MHz and 618.1-619 MHz, and assuming a subcarrier spacing of 15 kHz) as the guard gap.

The network-side device may also deploy the downlink frequency domain resource and/or the flexible frequency domain resource in at least part of the target area in the band of the uplink BWP or the uplink carrier. As shown in the right spectrum diagram in FIG. 5, the downlink frequency domain resource (the flexible frequency domain resource may be used as the downlink frequency domain resource) is located anywhere in the uplink BWP or the uplink carrier except at the edge in the band.

The uplink frequency domain resource may also be located in the remaining target area in a case that the downlink frequency domain resource and/or the flexible frequency domain resource are/is located in at least part of the target area in the band of the uplink BWP or the uplink carrier.

According to the transmission method provided by the embodiments of this application, since an uplink or downlink frequency domain resource is located at an edge in a band of a corresponding BWP or carrier and frequency domain resources in other transmission directions are deployed in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In the network-side device, the guard gaps are arranged between the downlink frequency domain resource and the uplink frequency domain resource, between the downlink frequency domain resource and the flexible frequency domain resource, between the uplink frequency domain resource and the flexible frequency domain resource, and between the flexible frequency domain resources, as shown in FIG. 4 and FIG. 5, so as to ensure that the downlink frequency domain resource, the uplink frequency domain resource, and the flexible frequency domain resource are not interfered with each other, thereby ensuring the smooth progress of communication.

In one embodiment, a frequency domain resource supporting flexible duplexing is configured as the flexible frequency domain resource.

The network-side device may configure the frequency domain resource supporting flexible duplexing as the flexible frequency domain resource.

As shown in FIG. 6, the network-side device may configure the frequency domain resource supporting flexible duplexing as the flexible frequency domain resource in a case that the downlink frequency domain resource is located at the edge in the band of the downlink BWP or the downlink carrier. It is to be noted that FIG. 6 only shows two examples where the network-side device configures the frequency domain resource supporting flexible duplexing as the flexible frequency domain resource for the downlink BWP or the downlink carrier. On the basis of the embodiments of the present application, there may be various ways to configure the frequency domain resource supporting flexible duplexing as the flexible frequency domain resource, which are not exemplified one by one in this specification.

As shown in FIG. 7, the network-side device may configure the frequency domain resource supporting flexible duplexing as the flexible frequency domain resource in a case that the uplink frequency domain resource is located at the edge in the band of the uplink BWP or the uplink carrier. It is to be noted that FIG. 7 only shows two examples where the network-side device configures the frequency domain resource supporting flexible duplexing as the flexible frequency domain resource for the uplink BWP or the uplink carrier. On the basis of the embodiments of the present application, there may be various ways to configure the frequency domain resource supporting flexible duplexing as the flexible frequency domain resource, which are not exemplified one by one in this specification.

In one embodiment, the locations of the frequency domain resources may further include at least one of the following:

the downlink frequency domain resource is configured with a control resource set CORESET; or

the flexible frequency domain resource is configured with a CORESET in a case that the flexible frequency domain resource is used as the downlink frequency domain resource.

As shown in FIG. 8, the network-side device may configure the CORESET on the downlink frequency domain resource located at the edge in the band of the downlink BWP or the downlink carrier, or on the downlink frequency domain resource located in the target area, or on the downlink frequency domain resource originally used as the flexible frequency domain resource, or on a combination of the above frequency domain resources.

In order to reduce the influence on the CORESET configuration of a backward terminal, the network-side device may configure a full duplexing bandwidth and TDM of a symbol where the CORESET is located.

It is to be understood that by configuring the CORESET on some downlink frequency domain resource, it may be ensured that the terminal will not be unable to use an effective CORESET when the downlink BWP or the downlink carrier is used for uplink services, thus affecting the normal communication.

It is to be noted that when a BWP is changed to time units (for example, slot n and slot n+m in FIG. 8) of different frequency domain uplink and downlink patterns, the network-side device will set a conversion time interval of x (x≥x is a positive integer) symbols between the two time units, or set a conversion time interval of at least one slot (m≥m is a positive integer).

In one embodiment, the operation of determining locations of frequency domain resources may further include:

determining a location of the uplink frequency domain resource or the downlink frequency domain resource or the flexible frequency domain resource in a half-duplexing pattern.

As shown in FIG. 9, a left spectrum diagram shows that the network-side device will instruct the terminal to use the uplink frequency domain resource or the downlink resource at every time (conversion time is T) in a half-duplexing pattern in the related art. For example, the downlink frequency domain resource is used at time M, the uplink frequency domain resource is used at time N, the downlink frequency domain resource is used at time O), and the uplink frequency domain resource is used at time P. A transmission direction at every time is determined, and the downlink frequency domain resource and the uplink frequency domain resource cannot change the transmission direction.

In the transmission method provided by the embodiments of this application, the network-side device may configure and instruct the terminal to use the uplink frequency domain resource, the downlink frequency domain resource, or the flexible frequency domain resource (used as the uplink frequency domain resource or the downlink frequency domain resource) according to the service requirements.

As shown in FIG. 9, a right spectrum diagram shows the locations of frequency domain resources in the half-duplexing pattern in the embodiments of this application: there may be the uplink frequency domain resource or the downlink frequency domain resource at every time.

For example, there may be the downlink frequency domain resource at time M, the uplink frequency domain resource at time N, the uplink frequency domain resource at time O, and the downlink frequency domain resource at time P. The transmission direction at every time may be notified by the network, and the corresponding downlink frequency domain resource and uplink frequency domain resource at every time may change the transmission direction.

As can be seen from the right spectrum diagram of FIG. 9, in the transmission method provided by the embodiments of this application, the uplink frequency domain resource, the downlink frequency domain resource, and the flexible frequency domain resource may be flexibly used according to actual service requirements, thereby improving the utilization of the frequency domain resources in the half-duplexing pattern.

In one embodiment, the transmission method provided by the embodiments of this application may further include:

stopping using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

When a full duplexing downlink frequency domain resource is used as the uplink frequency domain resource, the influence on synch-raster/SSB/Coreset 0 shall be avoided.

Therefore, in the embodiments of this application, when there is an SSB/Coreset 0 on a flexible frequency resource or a downlink frequency domain resource, the network-side device will avoid using the flexible frequency domain resource or the downlink frequency domain resource as the uplink frequency domain resource to avoid affecting backward UE.

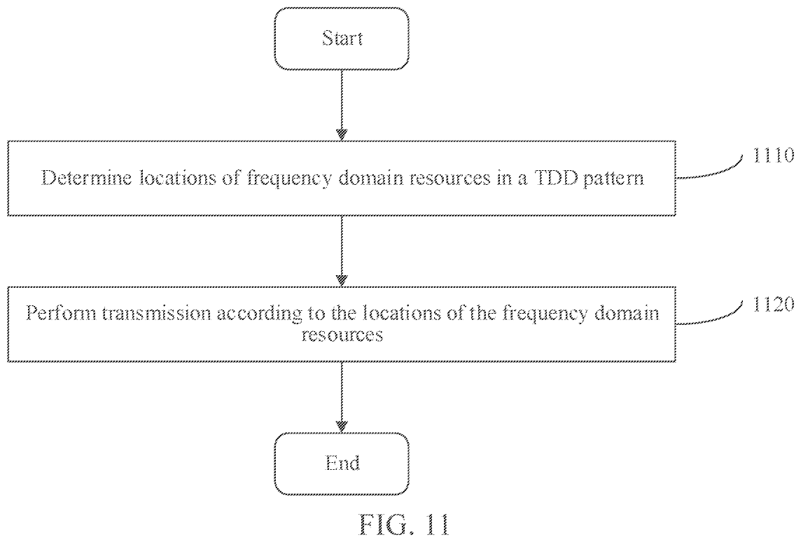

FIG. 11 is a schematic flowchart 3 of a transmission method according to an embodiment of this application Referring to FIG. 11, the embodiments of this application provide a transmission method, which may include the following steps:

Step 1110: Determine locations of frequency domain resources in a TDD pattern.

Step 1120: Perform transmission according to the locations of the frequency domain resources.

The locations of the frequency domain resources include any one of the following:

a downlink frequency domain resource is located at an edge in a band of a BWP or a carrier corresponding to a downlink slot, and an uplink frequency domain resource and/or a flexible frequency domain resource are/is located in at least part of a target area in the band of the BWP or the carrier corresponding to the downlink slot, or

an uplink frequency domain resource is located at an edge in a band of a BWP or a carrier corresponding to an uplink slot, and a downlink frequency domain resource and/or a flexible frequency domain resource are/is located in at least part of a target area in the band of the BWP or the carrier corresponding to the uplink slot.

The target area is an area other than the edge in the band.

It is to be noted that the executive entity of the transmission method provided by the embodiments of this application may be a terminal, such as a mobile phone or a computer. The technical solution of this application is described in detail based on an example where the transmission method provided by the embodiments of this application is performed by the terminal.

The terminal may determine locations of frequency domain resources prior to transmission (for example, uplink transmission).

After determining the locations of the frequency domain resources, the terminal may perform corresponding transmission according to the locations of the frequency domain resources. For example, the terminal may perform uplink transmission at an uplink frequency domain resource after confirming a location of the uplink frequency domain resource.

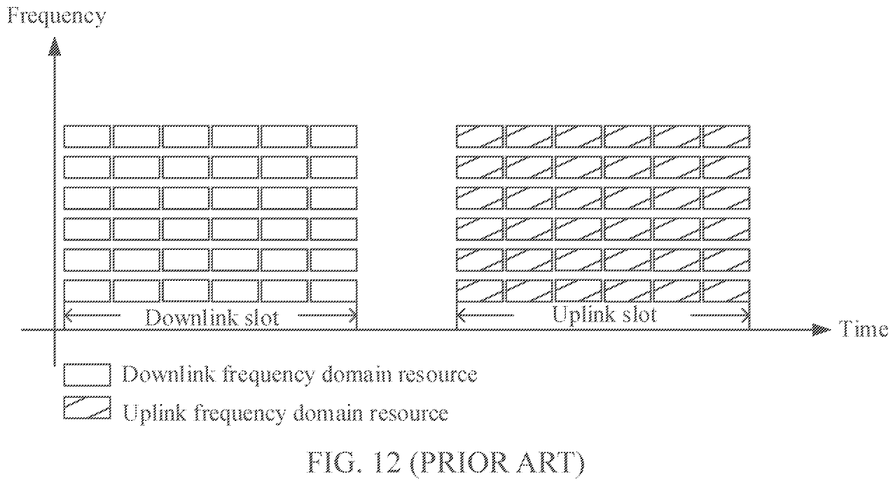

As shown in FIG. 12, the network-side device deploys the downlink frequency domain resource in the related art in the following manner: the downlink frequency domain resource is located in the whole BWP or carrier corresponding to a downlink slot, and the uplink frequency domain resource is located in the whole BWP or carrier corresponding to an uplink slot.

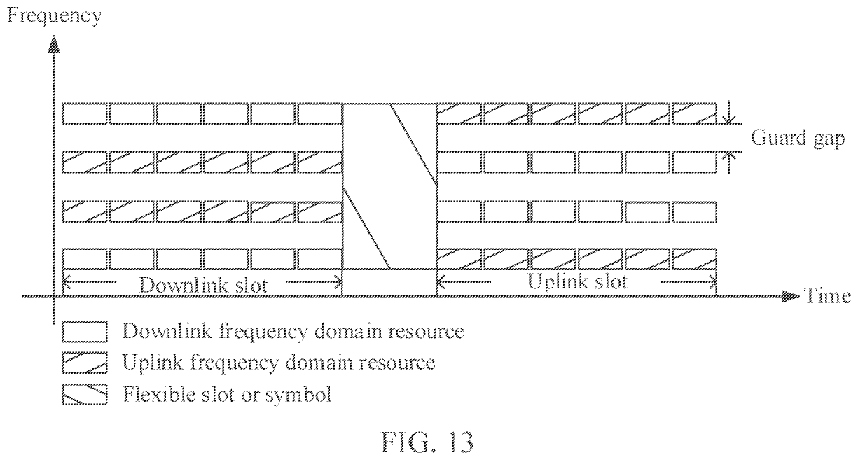

As shown in FIG. 13, in the transmission method provided by the embodiments of this application, a downlink frequency domain resource is located at an edge in a band of a BWP or a carrier corresponding to a downlink slot, and an uplink frequency domain resource and/or a flexible frequency domain resource are/is located in at least part of a target area in the band of the BWP or the carrier corresponding to the downlink slot.

It is to be noted that for example, an edge in a band of a BWP or a carrier corresponding to a downlink slot of 600-619 MHz may correspond to a predefined bandwidth, such as 600-601 MHz and 618-619 MHz. In the related art, for channel bandwidth, the edge in the band is usually defined as an integer multiple of RB or a guard gap.

In the embodiments of this application, the network-side device may deploy the downlink frequency domain resource at the edge in the band of the BWP or the carrier corresponding to the downlink slot. For example, in a case that the BWP or the carrier corresponding to the downlink slot corresponds to 110 RBs, the network-side device may deploy a part of the 110 RBs, for example, 100 RBs, as the downlink frequency domain resource, and deploy the remaining 5 RBs at the outermost ends of the band (for example RBs corresponding to 600-600.9 MHz and 618.1-619 MHz, and assuming a subcarrier spacing of IS kHz) as the guard gap.

It is to be noted that the flexible frequency domain resource refers to the frequency domain resource used as both the uplink frequency domain resource and the downlink frequency domain resource.

The network-side device may also deploy the uplink frequency domain resource and/or the flexible frequency domain resource in at least part of the target area in the band of the BWP or the carrier corresponding to the downlink slot. As shown in FIG. 13, the uplink frequency domain resource (the flexible frequency domain resource may be used as the uplink frequency domain resource) is located anywhere in the BWP or the carrier corresponding to the downlink slot except at the edge in the band.

The downlink frequency domain resource may also be located in the remaining target area in a case that the uplink frequency domain resource and/or the flexible frequency domain resource are/is located in at least part of the target area in the band of the BWP or the carrier corresponding to the downlink slot.

As shown in FIG. 13, in the transmission method provided by the embodiments of this application, an uplink frequency domain resource is located at an edge in a band of a BWP or a carrier corresponding to an uplink slot, and an uplink frequency domain resource and/or a flexible frequency domain resource are/is located in at least part of a target area in the band of the BWP or the carrier corresponding to the uplink slot.

It is to be noted that for example, an edge in a band of a BWP or a carrier corresponding to an uplink slot of 600-619 MHz may be, for example, 600-601 MHz and 618-619 MHz, correspondingly. In the related art, for channel bandwidth, the edge in the band is usually defined as an integer multiple of RB or a guard gap.

In the embodiments of this application, the network-side device may deploy the uplink frequency domain resource at the edge in the band of the BWP or the carrier corresponding to the uplink slot. For example, in a case that the BWP or the carrier corresponding to the uplink slot corresponds to 110 RBs, the network-side device may deploy a part of the 110 RBs, for example, 100 RBs, as the uplink frequency domain resource, and deploy the remaining 5 RBs at the outermost ends of the band (for example, RBs corresponding to 600-600.9 MHz and 618.1-619 MHz, and assuming a subcarrier spacing of IS kHz) as the guard gap.

The network-side device may also deploy the downlink frequency domain resource and/or the flexible frequency domain resource in at least part of the target area in the band of the BWP or the carrier corresponding to the uplink slot. As shown in FIG. 14, the network-side device may deploy the downlink frequency domain resource (the flexible frequency domain resource may be used as the downlink frequency domain resource) anywhere in the BWP or the carrier corresponding to the uplink slot except at the edge in the band.

The uplink frequency domain resource may be located in the remaining target area in a case that the downlink frequency domain resource and/or the flexible frequency domain resource are/is located in at least part of the target area in the band of the BWP or the carrier corresponding to the uplink slot.

According to the frequency domain resource deployment method provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In the network-side device, the guard gaps are arranged between the downlink frequency domain resource and the uplink frequency domain resource, between the downlink frequency domain resource and the flexible frequency domain resource, between the uplink frequency domain resource and the flexible frequency domain resource, and between the flexible frequency domain resources, as shown in FIG. 13, so as to ensure that the downlink frequency domain resource, the uplink frequency domain resource, and the flexible frequency domain resource are not interfered with each other, thereby ensuring the smooth progress of communication.

In one embodiment, a flexible slot or a predetermined quantity of symbols are arranged between the uplink slot and the downlink slot.

As shown in FIG. 13, the network-side device may arrange a flexible slot between the uplink slot and the downlink slot. The flexible slot refers to a slot which may be used as the uplink slot or the downlink slot.

The network-side device may also arrange a predetermined quantity of symbols between the uplink slot and the downlink slot, such as five symbols, ten symbols and the like. The specific size of the predetermined quantity may be adjusted according to actual situations, which is not specifically limited in the embodiments of this application.

It is to be noted that the flexible slot or the predetermined quantity of symbols arranged between the uplink slot and the downlink slot may be used as an uplink-to-downlink conversion spacing, so as to ensure the smooth progress of communication.

In one embodiment, the deployment locations of the frequency domain resources may further include:

the frequency domain resources at the edge of the band are deployed, in the presence of an interference frequency range, as frequency domain resources in the same transmission direction as frequency domain resources of the interference frequency range.

The interference frequency range may be a frequency range of a BWP or a carrier from another operator, or another base station of the same network operator.

As shown in FIG. 14, the network-side device may deploy the frequency domain resources at the edge in the band as frequency domain resources in the same transmission direction as frequency domain resources of the interference frequency range. For example, when the transmission direction of the interference frequency range in a slot is downlink transmission, the network-side device may deploy an edge in a band in the slot as the downlink frequency domain resource. When the transmission direction of the interference frequency range in a slot is uplink transmission, the network-side device may deploy an edge in a band in the slot as the uplink frequency domain resource.

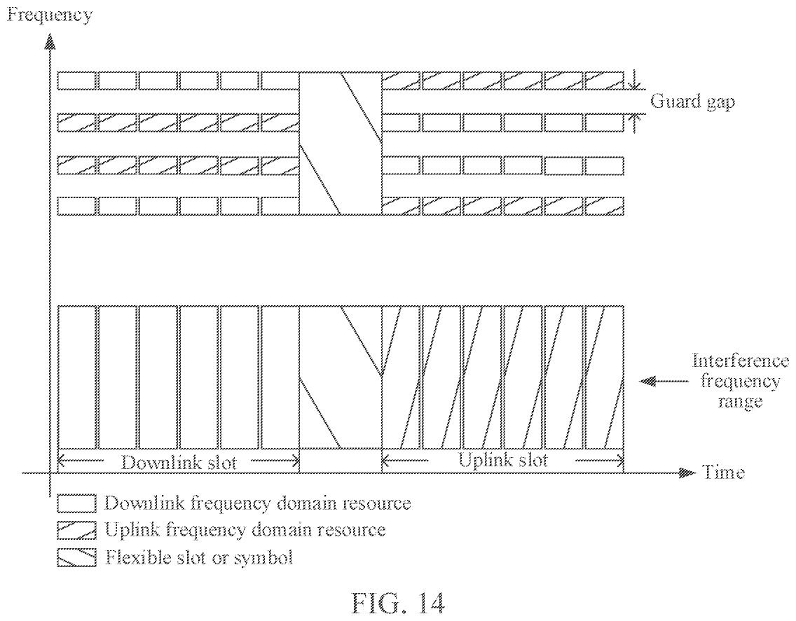

As shown in FIG. 15, in a case that the network-side device works in an FDD pattern, the interference frequency range is a TDD pattern and a frequency range configured by the network-side device is close to the interference frequency range, if the network-side device finds that the interference frequency range still brings adjacent channel interference and the uplink traffic to be processed by the network-side device is not large, the network-side device may change a part of the uplink frequency resource into the downlink frequency resource by time division, so as to reduce downlink interference to or from the interference frequency range.

Similarly, if the network-side device finds that the interference frequency range has adjacent channel interference and the downlink traffic to be processed by the network-side device is not large, the network-side device may change a part of the downlink frequency resource into the uplink frequency resource by time division, so as to reduce uplink interference to the interference frequency range.

By deploying the frequency domain resources at the edge in the band as frequency domain resources in the same transmission direction as frequency domain resources of the interference frequency range, the interference to or from the interference frequency range can be reduced, thus improving the quality of communication.

In one embodiment, a frequency domain resource supporting flexible duplexing is configured as the flexible frequency domain resource.

The network-side device may configure the frequency domain resource supporting flexible duplexing as the flexible frequency domain resource.

As shown in FIG. 6, the network-side device may configure the frequency domain resource supporting flexible duplexing as the flexible frequency domain resource in a case that the downlink frequency domain resource is located at the edge in the band of the BWP or the carrier corresponding to the downlink slot. It is to be noted that FIG. 6 only shows two examples where the network-side device configures the frequency domain resource supporting flexible duplexing as the flexible frequency domain resource for the BWP or the carrier corresponding to the downlink slot. On the basis of the embodiments of the present application, there may be various ways to configure the frequency domain resource supporting flexible duplexing as the flexible frequency domain resource, which are not exemplified one by one in this specification.

As shown in FIG. 7, the network-side device may configure the frequency domain resource supporting flexible duplexing as the flexible frequency domain resource in a case that the uplink frequency domain resource is located at the edge in the band of the BWP or the carrier corresponding to the uplink slot. It is to be noted that FIG. 7 only shows two examples where the network-side device configures the frequency domain resource supporting flexible duplexing as the flexible frequency domain resource for the BWP or the carrier corresponding to the uplink slot. On the basis of the embodiments of the present application, there may be various ways to configure the frequency domain resource supporting flexible duplexing as the flexible frequency domain resource, which are not exemplified one by one in this specification.

In one embodiment, the deployment locations of the frequency domain resources may further include at least one of the following:

the downlink frequency domain resource is configured with a control resource set CORESET; or

the flexible frequency domain resource is configured with a CORESET in a case that the flexible frequency domain resource is used as the downlink frequency domain resource.

As shown in FIG. 8, the network-side device may configure the CORESET on the downlink frequency domain resource located at the edge in the band of the BWP or the carrier corresponding to the downlink slot, or on the downlink frequency domain resource located in the target area, or on the downlink frequency domain resource originally used as the flexible frequency domain resource, or on a combination of the above frequency domain resources.

In order to reduce the influence on the CORESET configuration of a backward terminal, the network-side device may configure a full duplexing bandwidth and TDM of a symbol where the CORESET is located.

It is to be understood that by configuring the CORESET on some downlink frequency domain resource, it may be ensured that the terminal will not be unable to use an effective CORESET when the downlink BWP or the downlink carrier is used for uplink services, thus affecting the normal communication.

In one embodiment, the transmission method provided by the embodiments of this application may further include:

stopping using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

When a full duplexing downlink frequency domain resource is used as the uplink frequency domain resource, the influence on synch-raster/SSB/Coreset 0 shall be avoided.

Therefore, in the embodiments of this application, when there is an SSB/Coreset 0 on a flexible frequency resource, the terminal will stop using the flexible frequency domain resource as the uplink frequency domain resource to avoid affecting backward UE.

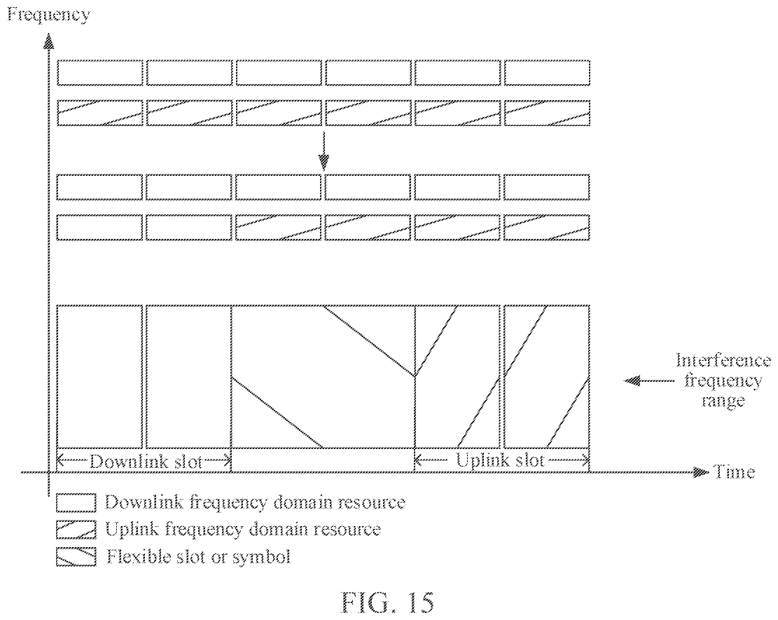

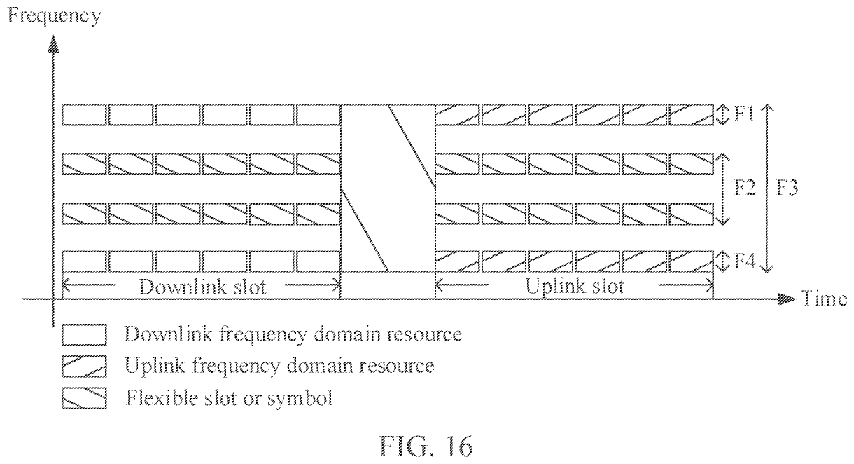

In one embodiment, as shown in FIG. 16, a backward terminal may use frequency domain resources F1 or F2 or F4 by scheduling or configuration. The network-side device may configure corresponding SSBs in these frequency domain resources. A terminal supporting full duplexing or flexible duplexing may use a frequency domain resource F3.

The backward terminal may use the frequency domain resources F1 and F4 by scheduling or configuration. For example, for an RRC connected terminal, a Physical Uplink Control Channel (PUCCH) or a Physical Uplink Shared Channel (PUSCH) may be instructed to use the frequency domain resources of F1 and F4 to obtain diversity gains, respectively.

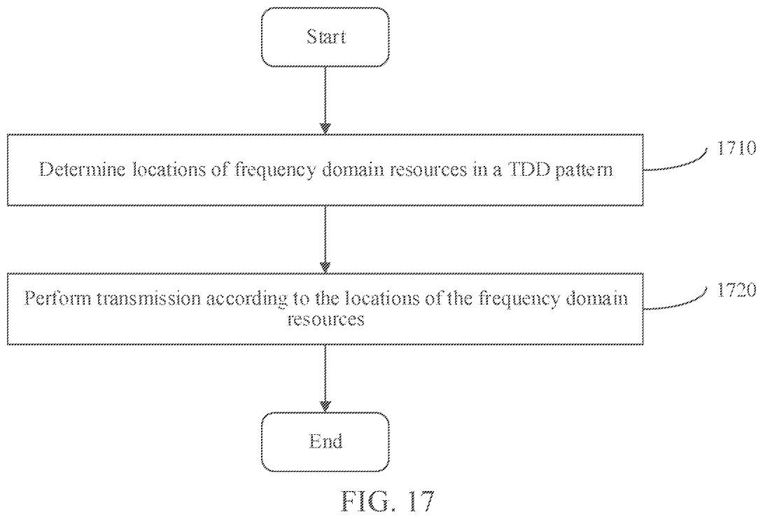

FIG. 17 is a schematic flowchart 4 of a transmission method according to an embodiment of this application. Referring to FIG. 17, the embodiments of this application provide a transmission method, which may include the following steps:

Step 1710. Determine locations of frequency domain resources in a TDD pattern.

Step 1720: Perform transmission according to the locations of the frequency domain resources.

The locations of the frequency domain resources include any one of the following:

a downlink frequency domain resource is located at an edge in a band of a BWP or a carrier corresponding to a downlink slot, and an uplink frequency domain resource and/or a flexible frequency domain resource are/is located in at least part of a target area in the band of the BWP or the carrier corresponding to the downlink slot; or

an uplink frequency domain resource is located at an edge in a band of a BWP or a carrier corresponding to an uplink slot, and a downlink frequency domain resource and/or a flexible frequency domain resource are/is located in at least part of a target area in the band of the BWP or the carrier corresponding to the uplink slot.

The target area is an area other than the edge in the band.

It is to be noted that the executive entity of the frequency domain resource deployment method provided by the embodiments of this application may be a network-side device, such as a base station or a core network. The technical solution of this application is described in detail based on an example where the frequency domain resource deployment method provided by the embodiments of this application is performed by the network-side device.

The network-side device may determine locations of frequency domain resources prior to transmission (for example, downlink transmission).

After determining the locations of the frequency domain resources, the network-side device may perform corresponding transmission according to the locations of the frequency domain resources. For example, the network-side device may perform downlink transmission at a downlink frequency domain resource after confirming a location of the downlink frequency domain resource.

As shown in FIG. 12, the network-side device deploys the downlink frequency domain resource in the related art in the following manner: the downlink frequency domain resource is located in the whole BWP or carrier corresponding to a downlink slot, and the uplink frequency domain resource is located in the whole BWP or carrier corresponding to an uplink slot.

As shown in FIG. 13, in the transmission method provided by the embodiments of this application, a downlink frequency domain resource is located at an edge in a band of a BWP or a carrier corresponding to a downlink slot, and an uplink frequency domain resource and/or a flexible frequency domain resource are/is located in at least part of a target area in the band of the BWP or the carrier corresponding to the downlink slot.

It is to be noted that for example, an edge in a band of a BWP or a carrier corresponding to a downlink slot of 600-619 MHz may correspond to a predefined bandwidth, such as 600-601 MHz and 618-619 MHz. In the related art, for channel bandwidth, the edge in the band is usually defined as an integer multiple of RB or a guard gap.

In the embodiments of this application, the network-side device may deploy the downlink frequency domain resource at the edge in the band of the BWP or the carrier corresponding to the downlink slot. For example, in a case that the BWP or the carrier corresponding to the downlink slot corresponds to 110 RBs, the network-side device may deploy a part of the 110 RBs, for example, 100 RBs, as the downlink frequency domain resource, and deploy the remaining 5 RBs at the outermost ends of the band (for example RBs corresponding to 600-600.9 MHz and 618.1-619 MHz, and assuming a subcarrier spacing of IS kHz) as the guard gap.

It is to be noted that the flexible frequency domain resource refers to the frequency domain resource used as both the uplink frequency domain resource and the downlink frequency domain resource.

The network-side device may also deploy the uplink frequency domain resource and/or the flexible frequency domain resource in at least part of the target area in the band of the BWP or the carrier corresponding to the downlink slot. As shown in FIG. 13, the uplink frequency domain resource (the flexible frequency domain resource may be used as the uplink frequency domain resource) is located anywhere in the BWP or the carrier corresponding to the downlink slot except at the edge in the band.

The downlink frequency domain resource may also be located in the remaining target area in a case that the uplink frequency domain resource and/or the flexible frequency domain resource are/is located in at least part of the target area in the band of the BWP or the carrier corresponding to the downlink slot.

As shown in FIG. 13, in the transmission method provided by the embodiments of this application, an uplink frequency domain resource is located at an edge in a band of a BWP or a carrier corresponding to an uplink slot, and an uplink frequency domain resource and/or a flexible frequency domain resource are/is located in at least part of a target area in the band of the BWP or the carrier corresponding to the uplink slot.

It is to be noted that for example, an edge in a band of a BWP or a carrier corresponding to an uplink slot of 600-619 MHz may be, for example, 600-601 MHz and 618-619 MHz, correspondingly. In the related art, for channel bandwidth, the edge in the band is usually defined as an integer multiple of RB or a guard gap.

In the embodiments of this application, the network-side device may deploy the uplink frequency domain resource at the edge in the band of the BWP or the carrier corresponding to the uplink slot. For example, in a case that the BWP or the carrier corresponding to the uplink slot corresponds to 110 RBs, the network-side device may deploy a part of the 110 RBs, for example, 100 RBs, as the uplink frequency domain resource, and deploy the remaining 5 RBs at the outermost ends of the band (for example, RBs corresponding to 600-600.9 MHz and 618.1-619 MHz, and assuming a subcarrier spacing of IS kHz) as the guard gap.

The network-side device may also deploy the downlink frequency domain resource and/or the flexible frequency domain resource in at least part of the target area in the band of the BWP or the carrier corresponding to the uplink slot. As shown in FIG. 14, the network-side device may deploy the downlink frequency domain resource (the flexible frequency domain resource may be used as the downlink frequency domain resource) anywhere in the BWP or the carrier corresponding to the uplink slot except at the edge in the band.

The uplink frequency domain resource may be located in the remaining target area in a case that the downlink frequency domain resource and/or the flexible frequency domain resource are/is located in at least part of the target area in the band of the BWP or the carrier corresponding to the uplink slot.

According to the frequency domain resource deployment method provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In the network-side device, the guard gaps are arranged between the downlink frequency domain resource and the uplink frequency domain resource, between the downlink frequency domain resource and the flexible frequency domain resource, between the uplink frequency domain resource and the flexible frequency domain resource, and between the flexible frequency domain resources, as shown in FIG. 13, so as to ensure that the downlink frequency domain resource, the uplink frequency domain resource, and the flexible frequency domain resource are not interfered with each other, thereby ensuring the smooth progress of communication.

In one embodiment, a flexible slot or a predetermined quantity of symbols are arranged between the uplink slot and the downlink slot.

As shown in FIG. 13, the network-side device may arrange a flexible slot between the uplink slot and the downlink slot. The flexible slot refers to a slot which may be used as the uplink slot or the downlink slot.

The network-side device may also arrange a predetermined quantity of symbols between the uplink slot and the downlink slot, such as five symbols, ten symbols and the like. The specific size of the predetermined quantity may be adjusted according to actual situations, which is not specifically limited in the embodiments of this application.

It is to be noted that the flexible slot or the predetermined quantity of symbols arranged between the uplink slot and the downlink slot may be used as an uplink-to-downlink conversion spacing, so as to ensure the smooth progress of communication.

In one embodiment, the deployment locations of the frequency domain resources may further include:

the frequency domain resources at the edge of the band are deployed, in the presence of an interference frequency range, as frequency domain resources in the same transmission direction as frequency domain resources of the interference frequency range.

The interference frequency range may be a frequency range of a BWP or a carrier from another operator, or another base station of the same network operator.

As shown in FIG. 14, the network-side device may deploy the frequency domain resources at the edge in the band as frequency domain resources in the same transmission direction as frequency domain resources of the interference frequency range. For example, when the transmission direction of the interference frequency range in a slot is downlink transmission, the network-side device may deploy an edge in a band in the slot as the downlink frequency domain resource. When the transmission direction of the interference frequency range in a slot is uplink transmission, the network-side device may deploy an edge in a band in the slot as the uplink frequency domain resource.

As shown in FIG. 15, in a case that the network-side device works in an FDD pattern, the interference frequency range is a TDD pattern and a frequency range configured by the network-side device is close to the interference frequency range, if the network-side device finds that the interference frequency range still brings adjacent channel interference and the uplink traffic to be processed by the network-side device is not large, the network-side device may change a part of the uplink frequency resource into the downlink frequency resource by time division, so as to reduce downlink interference to or from the interference frequency range.

Similarly, if the network-side device finds that the interference frequency range has adjacent channel interference and the downlink traffic to be processed by the network-side device is not large, the network-side device may change a part of the downlink frequency resource into the uplink frequency resource by time division, so as to reduce uplink interference to the interference frequency range.

By deploying the frequency domain resources at the edge in the band as frequency domain resources in the same transmission direction as frequency domain resources of the interference frequency range, the interference to or from the interference frequency range can be reduced, thus improving the quality of communication.

In one embodiment, a frequency domain resource supporting flexible duplexing is configured as the flexible frequency domain resource.

The network-side device may configure the frequency domain resource supporting flexible duplexing as the flexible frequency domain resource.

As shown in FIG. 6, the network-side device may configure the frequency domain resource supporting flexible duplexing as the flexible frequency domain resource in a case that the downlink frequency domain resource is located at the edge in the band of the BWP or the carrier corresponding to the downlink slot. It is to be noted that FIG. 6 only shows two examples where the network-side device configures the frequency domain resource supporting flexible duplexing as the flexible frequency domain resource for the BWP or the carrier corresponding to the downlink slot. On the basis of the embodiments of the present application, there may be various ways to configure the frequency domain resource supporting flexible duplexing as the flexible frequency domain resource, which are not exemplified one by one in this specification.

As shown in FIG. 7, the network-side device may configure the frequency domain resource supporting flexible duplexing as the flexible frequency domain resource in a case that the uplink frequency domain resource is located at the edge in the band of the BWP or the carrier corresponding to the uplink slot. It is to be noted that FIG. 7 only shows two examples where the network-side device configures the frequency domain resource supporting flexible duplexing as the flexible frequency domain resource for the BWP or the carrier corresponding to the uplink slot. On the basis of the embodiments of the present application, there may be various ways to configure the frequency domain resource supporting flexible duplexing as the flexible frequency domain resource, which are not exemplified one by one in this specification.

In one embodiment, the deployment locations of the frequency domain resources may further include at least one of the following:

the downlink frequency domain resource is configured with a control resource set CORESET; or

the flexible frequency domain resource is configured with a CORESET in a case that the flexible frequency domain resource is used as the downlink frequency domain resource.

As shown in FIG. 8, the network-side device may configure the CORESET on the downlink frequency domain resource located at the edge in the band of the BWP or the carrier corresponding to the downlink slot, or on the downlink frequency domain resource deployed in the target area, or on the downlink frequency domain resource originally used as the flexible frequency domain resource, or on a combination of the above frequency domain resources.

In order to reduce the influence on the CORESET configuration of a backward terminal, the network-side device may configure a full duplexing bandwidth and TDM of a symbol where the CORESET is located.

It is to be understood that by configuring the CORESET on some downlink frequency domain resource, it may be ensured that the terminal will not be unable to use an effective CORESET when the downlink BWP or the downlink carrier is used for uplink services, thus affecting the normal communication.

In one embodiment, the transmission method provided by the embodiments of this application may further include:

stopping using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

When a full duplexing downlink frequency domain resource is used as the uplink frequency domain resource, the influence on sychraster/SSB/Coreset 0 shall be avoided.

Therefore, in the embodiments of this application, when there is an SSB)/Coreset 0 on a flexible frequency resource, the network-side device will avoid using the flexible frequency domain resource as the uplink frequency domain resource to avoid affecting backward UE.

In one embodiment, the network-side device may configure the first y symbols in each slot or slot of period x to be downlink, where y may be configured by the network-side device, and the transmission directions of other resources may be configured or changed by the network, so as to provide flexibility.

In one embodiment, as shown in FIG. 16, a backward terminal may use frequency domain resources F1 or F2 or F4 by scheduling or configuration. The network-side device may configure corresponding SSBs in these frequency domain resources. A terminal supporting full duplexing or flexible duplexing may use a frequency domain resource F3.

The backward terminal may use the frequency domain resources F1 and F4 by scheduling or configuration. For example, for an RRC connected terminal, a PUCCH or a PUSCH may be instructed to use the frequency domain resources of F1 and F4 to obtain diversity gains, respectively.

It is to be noted that the executive entity of the frequency domain resource deployment method provided by the embodiments of this application may be a frequency domain resource deployment apparatus or a control module in the frequency domain resource deployment apparatus for performing the frequency domain resource deployment method. In the embodiments of this application, the frequency domain resource deployment apparatus provided by the embodiments of this application is described by performing the frequency domain resource deployment method.

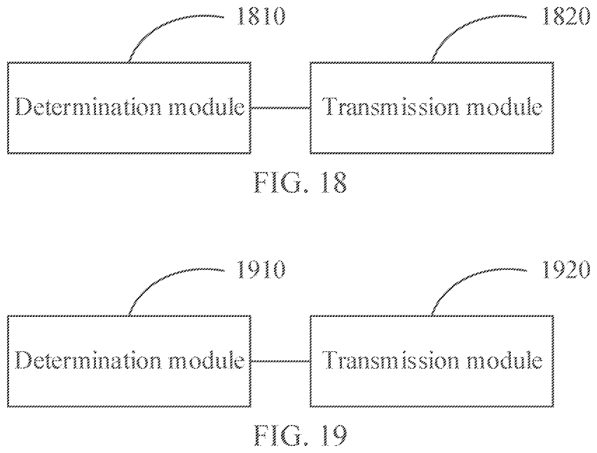

FIG. 18 is a schematic structural diagram 1 of a transmission apparatus according to an embodiment of this application. Referring to FIG. 18, the embodiments of this application provide a transmission apparatus applied to a terminal. The transmission apparatus may include:

a determination module 1810, configured to determine deployment locations of frequency domain resources in a frequency division duplexing FDD pattern; and

a transmission module 1820, configured to perform transmission according to the deployment locations of the frequency domain resources.

The deployment locations of the frequency domain resources include any one of the following:

a downlink frequency domain resource is deployed at an edge in a band of a downlink bandwidth part BWP or a downlink carrier, and an uplink frequency domain resource and/or a flexible frequency domain resource are/is deployed in at least part of a target area in the band of the downlink BWP or the downlink carrier; or

an uplink frequency domain resource is deployed at an edge in a band of an uplink BWP or an uplink carrier, and a downlink frequency domain resource and/or a flexible frequency domain resource are/is deployed in at least part of a target area in the band of the uplink BWP or the uplink carrier.

The target area is an area other than the edge in the band.

According to the transmission apparatus provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In one embodiment, a frequency domain resource supporting flexible duplexing is configured as the flexible frequency domain resource.

In one embodiment, the deployment locations of the frequency domain resources further include at least one of the following:

the downlink frequency domain resource is configured with a control resource set CORESET; or

the flexible frequency domain resource is configured with a CORESET in a case that the flexible frequency domain resource is used as the downlink frequency domain resource.

In one embodiment, the determination module 1810 is further configured to:

determine a deployment location of the uplink frequency domain resource or the downlink frequency domain resource or the flexible frequency domain resource in a half-duplexing pattern.

In one embodiment, the transmission module 1820 is further configured to:

stop using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

FIG. 19 is a schematic structural diagram 2 of a transmission apparatus according to an embodiment of this application. Referring to FIG. 19, the embodiments of this application provide a transmission apparatus applied to a network-side device. The transmission apparatus may include:

a determination module 1910, configured to determine deployment locations of frequency domain resources in a frequency division duplexing FDD pattern; and

a transmission module 1920, configured to perform transmission according to the deployment locations of the frequency domain resources.

The deployment locations of the frequency domain resources include any one of the following:

a downlink frequency domain resource is deployed at an edge in a band of a downlink bandwidth part BWP or a downlink carrier, and an uplink frequency domain resource and/or a flexible frequency domain resource are/is deployed in at least part of a target area in the band of the downlink BWP or the downlink carrier; or

an uplink frequency domain resource is deployed at an edge in a band of an uplink BWP or an uplink carrier, and a downlink frequency domain resource and/or a flexible frequency domain resource are/is deployed in at least part of a target area in the band of the uplink BWP or the uplink carrier.

The target area is an area other than the edge in the band.

According to the transmission apparatus provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In one embodiment, a frequency domain resource supporting flexible duplexing is configured as the flexible frequency domain resource.

In one embodiment, the deployment locations of the frequency domain resources further include at least one of the following:

the downlink frequency domain resource is configured with a control resource set CORESET: or

the flexible frequency domain resource is configured with a CORESET in a case that the flexible frequency domain resource is used as the downlink frequency domain resource.

In one embodiment, the determination module 1910 is further configured to:

determine a deployment location of the uplink frequency domain resource or the downlink frequency domain resource or the flexible frequency domain resource in a half-duplexing pattern.

In one embodiment, the transmission module 1920 is further configured to:

stop using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

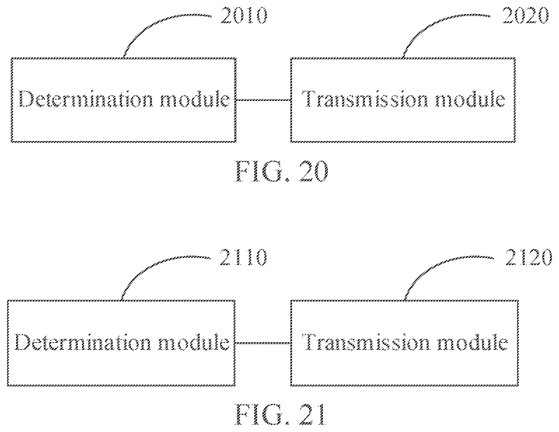

FIG. 20 is a schematic structural diagram 3 of a transmission apparatus according to an embodiment of this application. Referring to FIG. 20, the embodiments of this application provide a transmission apparatus applied to a terminal. The transmission apparatus may include:

a determination module 2010, configured to determine deployment locations of frequency domain resources in a time division duplexing TDD pattern; and

a transmission module 2020, configured to perform transmission according to the deployment locations of the frequency domain resources.

The deployment locations of the frequency domain resources include any one of the following:

a downlink frequency domain resource is deployed at an edge in a band of a bandwidth part BWP or a carrier corresponding to a downlink slot, and an uplink frequency domain resource and/or a flexible frequency domain resource are/is deployed in at least part of a target area in the band of the BWP or the carrier corresponding to the downlink slot; or

an uplink frequency domain resource is deployed at an edge in a band of a BWP or a carrier corresponding to an uplink slot, and a downlink frequency domain resource and/or a flexible frequency domain resource are/is deployed in at least part of a target area in the band of the BWP or the carrier corresponding to the uplink slot.

The target area is an area other than the edge in the band.

According to the transmission apparatus provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In one embodiment, a flexible slot or a predetermined quantity of symbols are arranged between the uplink slot and the downlink slot.

In one embodiment, the deployment locations of the frequency domain resources further include:

the frequency domain resources at the edge of the band are deployed, in the presence of an interference frequency range, as frequency domain resources in the same transmission direction as frequency domain resources of the interference frequency range.

In one embodiment, a frequency domain resource supporting flexible duplexing is configured as the flexible frequency domain resource.

In one embodiment, the deployment locations of the frequency domain resources further include at least one of the following:

the downlink frequency domain resource is configured with a control resource set CORESET; or

the flexible frequency domain resource is configured with a CORESET in a case that the flexible frequency domain resource is used as the downlink frequency domain resource.

In one embodiment, the transmission module 2020 is further configured to:

stop using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

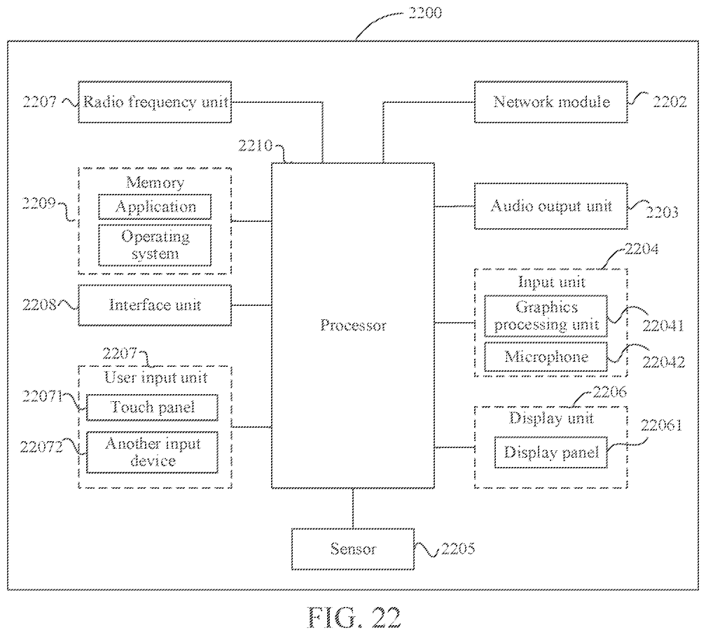

FIG. 21 is a schematic structural diagram 4 of a transmission apparatus according to an embodiment of this application. Referring to FIG. 21, the embodiments of this application provide a transmission apparatus applied to a network-side device. The transmission apparatus may include:

a determination module 2110, configured to determine deployment locations of frequency domain resources in a time division duplexing TDD pattern; and

a transmission module 2120, configured to perform transmission according to the deployment locations of the frequency domain resources.

The deployment locations of the frequency domain resources include any one of the following:

a downlink frequency domain resource is deployed at an edge in a band of a bandwidth part BWP or a carrier corresponding to a downlink slot, and an uplink frequency domain resource and/or a flexible frequency domain resource are/is deployed in at least part of a target area in the band of the BWP or the carrier corresponding to the downlink slot; or

an uplink frequency domain resource is deployed at an edge in a band of a BWP or a carrier corresponding to an uplink slot, and a downlink frequency domain resource and/or a flexible frequency domain resource are/is deployed in at least part of a target area in the band of the BWP or the carrier corresponding to the uplink slot.

The target area is an area other than the edge in the band.

According to the transmission apparatus provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

In one embodiment, a guard gap is arranged between every two of the downlink frequency domain resource, the uplink frequency domain resource, and the flexible frequency domain resource.

In one embodiment, a flexible slot or a predetermined quantity of symbols are arranged between the uplink slot and the downlink slot.

In one embodiment, the deployment locations of the frequency domain resources further include:

the frequency domain resources at the edge of the band are deployed, in the presence of an interference frequency range, as frequency domain resources in the same transmission direction as frequency domain resources of the interference frequency range.

In one embodiment, a frequency domain resource supporting flexible duplexing is configured as the flexible frequency domain resource.

In one embodiment, the deployment locations of the frequency domain resources further include at least one of the following:

the downlink frequency domain resource is configured with a control resource set CORESET; or

the flexible frequency domain resource is configured with a CORESET in a case that the flexible frequency domain resource is used as the downlink frequency domain resource.

In one embodiment, the transmission module 2020 is further configured to:

stop using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

The frequency domain resource deployment apparatus in the embodiments of this application may be an apparatus, an apparatus or electronic device with an operating system, and a component, an integrated circuit, or a chip in a terminal. The operating system may be an Android operating system, an ios operating system, or other possible operating systems, which is not specifically limited in the embodiments of this application. The apparatus or electronic device may be a mobile terminal or may be a non-mobile terminal. For example, the mobile terminal may include, but is not limited to, the type of the terminal 11 listed above, and the non-mobile terminal may be a server, a Network Attached Storage (NAS), a Personal Computer (PC), a Television (TV), an automatic teller machine, or a self-service machine, and the like. The embodiments of this application are not specifically limited.

The frequency domain resource deployment apparatus provided by the embodiments of this application may implement the processes implemented by the method embodiments of FIG. 3 to FIG. 17 and achieve the same technical effect. To avoid repetition, details are not described herein again.

The embodiments of this application further provide a terminal, including a processor and a communication interface. The processor is configured to: determine locations of frequency domain resources in a frequency division duplexing FDD pattern; and perform transmission according to the locations of the frequency domain resources. In some alternative embodiments, the processor is configured to: determine locations of frequency domain resources in a time division duplexing TDD pattern; and perform transmission according to the locations of the frequency domain resources. The terminal embodiment corresponds to the foregoing terminal-side method embodiments Each implementation process and implementation mode of the foregoing method embodiments may be applied to the terminal embodiment, and can achieve the same technical effect. For example, FIG. 22 is a schematic diagram of a hardware structure of a terminal according to an embodiment of this application.

The terminal 2200 includes, but is not limited to: at least some components such as a radio frequency unit 2201, a network module 2202, an audio output unit 2203, an input unit 2204, a sensor 2205, a display unit 2206, a user input unit 2207, an interface unit 2208, a memory 2209, and a processor 2210.

A person skilled in the art may understand that the terminal 2200 may further include a power supply (such as a battery) for supplying power to the components. The power supply may be logically connected to the processor 2210 by a power management system, thereby implementing functions such as charging, discharging, and power consumption management by using the power management system. The terminal structure shown in FIG. 22 does not constitute a limitation on the terminal, and the terminal may include more or fewer components than shown, or combine some components, or have different component arrangements, which are not described herein in detail.

It is to be understood that in the embodiments of this application, the input unit 2204 may include a Graphics Processing Unit (GPU) 22041 and a microphone 22042. The graphics processing unit 22041 performs processing on image data of a static picture or a video that is obtained by an image acquisition apparatus (for example, a camera) in a video acquisition mode or an image acquisition mode. The display unit 2206 may include a display panel 22061. The display panel 22061 may be configured in the form of a liquid crystal display, an organic light-emitting diode, or the like. The user input unit 2207 includes a touch panel 22071 and another input device 22072. The touch panel 22071 is also referred to as a touch screen. The touch panel 22071 may include two parts: a touch detection apparatus and a touch controller. The another input device 22072 may include, but not limited to, a physical keyboard, a functional key (such as a volume control key or a switch key), a track ball, a mouse, and a joystick, which are not described herein in detail.

In the embodiments of this application, the radio frequency unit 2201 receives downlink data from a network-side device and then transmits the downlink data to the processor 2210 for processing. In addition, uplink data is transmitted to the network-side device. Generally, the radio frequency unit 2201 includes, but is not limited to, an antenna, at least one amplifier, a transceiver, a coupler, a low noise amplifier, a duplexer, and the like.

The memory 2209 may be configured to store software programs or instructions and various data. The memory 2209 may mainly include a program or instruction storage area and a data storage area. The program or instruction storage area may store an operating system, applications or instructions required by at least one function (for example, a sound playback function and an image display function), and the like. In addition, the memory 2209 may include a high-speed random access memory and may further include a non-transient memory. The non-transient memory may be a Read-Only Memory (ROM), a Programmable ROM (PROM), an Erasable PROM (EPROM), an Electrically EPROM (EEPROM), or a flash memory. For example, the memory is at least one magnetic disk storage device, a flash memory device, or another non-transient solid-state storage device.

The processor 2210 may include one or more processing units. In some embodiments, the processor 2210 may integrate an application processor and a modem processor, where the application processor mainly processes an operating system, a user interface, applications or instructions, and the like, and the modem processor mainly processes wireless communication such as a baseband processor. It may be understood that the modem processor may not be integrated into the processor 2210.

In some embodiments, the processor 2210 is further configured to stop using the flexible frequency domain resource as the uplink frequency domain resource in a case that the flexible frequency domain resource satisfies a predetermined condition.

The predetermined condition includes:

the flexible frequency domain resource includes an SSB or CORESRT 0.

According to the terminal provided by the embodiments of this application, since an uplink or downlink frequency domain resource is located at an edge in a band of a corresponding BWP or carrier and frequency domain resources in other transmission directions are located in an area other than the edge in the band, the frequency domain resources may be flexibly deployed, thus improving the utilization of the frequency domain resources and reducing communication latency.

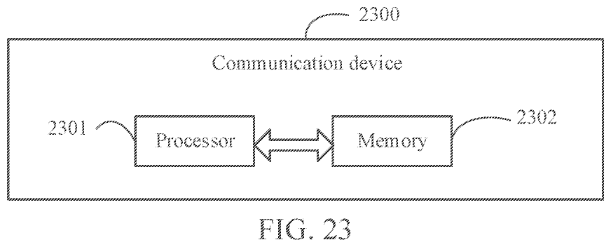

For example, as shown in FIG. 23, the embodiments of this application further provide a communication device 2300, including a processor 2301, a memory 2302, and programs or instructions stored in the memory 2302 and executable on the processor 2301. For example, the communication device 2300 is a network-side device, and the programs or instructions, when executed by the processor 2301, implement the processes of the foregoing transmission method embodiments and achieve the same technical effect. To avoid repetition, details are not described herein again.

The embodiments of this application further provide a network-side device, including a processor and a communication interface. The processor is configured to:

determine locations of frequency domain resources in a frequency division duplexing FDD pattern; and perform transmission based on the locations of the frequency domain resources; or

determine locations of frequency domain resources in a time division duplexing TDD pattern; and perform transmission according to the locations of the frequency domain resources.

The network-side device embodiment corresponds to the foregoing network-side device method embodiments. Each implementation process and implementation mode of the foregoing method embodiments may be applied to the network-side device embodiment, and can achieve the same technical effect.

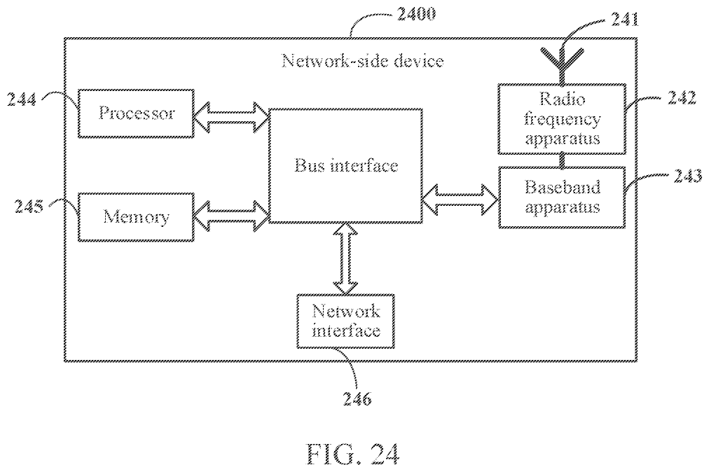

For example, the embodiments of this application further provide a network-side device. As shown in FIG. 24, a network device 2400 includes: an antenna 241, a radio frequency apparatus 242, and a baseband apparatus 243. The antenna 241 is connected to the radio frequency apparatus 242. In an uplink direction, the radio frequency apparatus 242 receives information through the antenna 241 and transmits the received information to the baseband apparatus 243 for processing. In a downlink direction, the baseband apparatus 243 processes information to be transmitted and transmits the information to the radio frequency apparatus 242. The radio frequency apparatus 242 processes the received information and transmits the processed information via the antenna 241.

The foregoing band processing apparatus may be located in the baseband apparatus 243. The method performed by the network-side device in the above embodiments may be implemented in the baseband apparatus 243. The baseband apparatus 243 includes a processor 244 and a memory 245.

The baseband apparatus 243 may, for example, include at least one baseband board. Multiple chips are disposed on the baseband board. As shown in FIG. 24, one of the chips is, for example, the processor 244, which is connected to the memory 245 to invoke programs in the memory 245, so as to perform network device operations shown in the above method embodiments.

The baseband apparatus 243 may further include a network interface 246 for exchanging information with the radio frequency apparatus 242. The interface is, for example, a Common Public Radio Interface (CPR1).

For example, the network-side device in the embodiments of the present application further includes: instructions or programs stored on the memory 24S and executable on the processor 244. The processor 244 invokes the instructions or programs in the memory 245 to perform the method performed by each module shown in FIG. 19 or FIG. 21 and to achieve the same technical effect. To avoid repetition, details are not described herein again.

The embodiments of this application further provide a readable storage medium. The readable storage medium stores programs or instructions. The programs or instructions, when executed by a processor, implement the processes of the foregoing transmission method embodiments and achieve the same technical effect. To avoid repetition, details are not described herein again.

The processor is a processor in the terminal in the foregoing embodiments. The readable storage medium includes a computer-readable storage medium such as an ROM, a Random Access Memory (RAM), a magnetic disk, or an optical disc.

The embodiments of this application also provide a chip. The chip includes a processor and a communication interface. The communication interface is coupled to the processor. The processor is configured to execute programs or instructions to implement the processes of the foregoing transmission method embodiments and achieve the same technical effect. To avoid repetition, details are not described herein again.

It is to be understood that the chip referred to in the embodiments of this application may also be referred to as a system-on-chip, and the like.

It is to be noted that the terms “include”, “comprise”, or any other variation thereof in this specification is intended to cover a non-exclusive inclusion, whereby a process, method, object, or apparatus including a series of elements not only includes those elements, but also includes other elements that are not explicitly listed, or also includes elements inherent to such process, method, object, or apparatus. Without more limitations, elements defined by the sentence “including a” does not exclude that there are still other same elements in the process, method, object, or apparatus. Furthermore, it is to be noted that the scope of the methods and apparatuses in the implementations of this application is not limited to performing functions in the order shown or discussed, but may also include performing functions in a substantially simultaneous manner or in reverse order depending on the functions involved. For example, the described methods may be performed in a different order than described, and various steps may be added, omitted, or combined. In addition, features described in some examples may also be combined in other examples.

According to the descriptions in the above implementations, a person skilled in the art may clearly learn that the method according to the foregoing embodiments may be implemented by relying on software and a general hardware platform or by using hardware. In some embodiments, the technical solutions of this application essentially, or the part contributing to the prior art, may be presented in the form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the various embodiments of this application.

The embodiments of this application have been described above with reference to the accompanying drawings. This application is not limited to the foregoing implementations, and the foregoing implementations are merely exemplary and not limitative. A person of ordinary skill in the art may make various forms under the teaching of this application without departing from the spirit of this application and the protection scope of the claims, and such forms shall all fall within the protection scope of this application.

What is claimed is:

1. A transmission method, comprising:
determining, by a terminal, locations of frequency domain resources in a Frequency Division Duplexing (FDD) pattern; and
performing, by the terminal, transmission according to the locations of the frequency domain resources,
wherein the locations of the frequency domain resources comprise any one of the following:
a downlink frequency domain resource located at an edge in a band of a downlink Bandwidth Part (BWP) or a downlink carrier, and an uplink frequency domain resource or a flexible frequency domain resource located in at least part of a target area in the band of the downlink BWP or the downlink carrier, or
an uplink frequency domain resource located at an edge in a band of an uplink BWP or an uplink carrier, and a downlink frequency domain resource or a flexible frequency domain resource located in at least part of a target area in the band of the uplink BWP or the uplink carrier,
wherein the target area is an area other than the edge in the band.

2. The transmission method according to claim 1, wherein a guard gap is arranged between every two of the downlink frequency domain resource, the uplink frequency domain resource, and the flexible frequency domain resource.

3. The transmission method according to claim 1, wherein a frequency domain resource supporting flexible duplexing is configured as the flexible frequency domain resource.

4. The transmission method according to claim 1, wherein the locations of the frequency domain resources further comprise at least one of the following:
the downlink frequency domain resource configured with a Control Resource Set (CORESET), or
the flexible frequency domain resource configured with a CORESET when the flexible frequency domain resource is used as the downlink frequency domain resource.

5. The transmission method according to claim 1, wherein the determining locations of frequency domain resources further comprises:
determining a location of the uplink frequency domain resource or the downlink frequency domain resource or the flexible frequency domain resource in a half-duplexing pattern.

6. The transmission method according to claim 1, further comprising:
stopping, by the terminal, using the flexible frequency domain resource as the uplink frequency domain resource when the flexible frequency domain resource satisfies a predetermined condition,
wherein the predetermined condition comprises:
the flexible frequency domain resource comprises a Synchronization Signal Block (SSB) or CORESRT 0.

7. A transmission method, comprising:
determining, by a terminal, locations of frequency domain resources in a Time Division Duplexing (TDD) pattern, and
performing, by the terminal, transmission according to the locations of the frequency domain resources,
wherein the locations of the frequency domain resources comprise any one of the following:
a downlink frequency domain resource located at an edge in a band of a Bandwidth Part (BWP) or a carrier corresponding to a downlink slot, and an uplink frequency domain resource or a flexible frequency domain resource located in at least part of a target area in the band of the BWP or the carrier corresponding to the downlink slot; or
an uplink frequency domain resource located at an edge in a band of a BWP or a carrier corresponding to an uplink slot, and a downlink frequency domain resource or a flexible frequency domain resource located in at least part of a target area in the band of the BWP or the carrier corresponding to the uplink slot,
wherein the target area is an area other than the edge in the band.

8. The transmission method according to claim 7, wherein a guard gap is arranged between every two of the downlink frequency domain resource, the uplink frequency domain resource, and the flexible frequency domain resource.

9. The transmission method according to claim 7, wherein a flexible slot or a predetermined quantity of symbols are arranged between the uplink slot and the downlink slot.

10. The transmission method according to claim 7, wherein the deployment locations of the frequency domain resources further comprise:
the frequency domain resources deployed at the edge of the band, in the presence of an interference frequency range, as frequency domain resources in the same transmission direction as frequency domain resources of the interference frequency range.

11. The transmission method according to claim 7, wherein a frequency domain resource supporting flexible duplexing is configured as the flexible frequency domain resource.

12. The transmission method according to claim 7, wherein the deployment locations of the frequency domain resources further comprise at least one of the following:
the downlink frequency domain resource configured with a Control Resource Set (CORESET); or
the flexible frequency domain resource configured with a CORESET when the flexible frequency domain resource is used as the downlink frequency domain resource.

13. The transmission method according to claim 7, further comprising:
stopping, by the terminal, using the flexible frequency domain resource as the uplink frequency domain resource when the flexible frequency domain resource satisfies a predetermined condition,
wherein the predetermined condition comprises:
the flexible frequency domain resource comprises a Synchronization Signal Block (SSB) or CORESRT 0.

14. A terminal, comprising: a processor; a memory having a computer program or an instruction stored thereon, wherein the computer program or the instruction, when executed by the processor, causes the processor to implement operations, comprising:
determining locations of frequency domain resources in a Frequency Division Duplexing (FDD) pattern; and
performing transmission according to the locations of the frequency domain resources,
wherein the locations of the frequency domain resources comprise any one of the following:
a downlink frequency domain resource located at an edge in a band of a downlink Bandwidth Part (BWP) or a downlink carrier, and an uplink frequency domain resource or a flexible frequency domain resource located in at least part of a target area in the band of the downlink BWP or the downlink carrier, or
an uplink frequency domain resource located at an edge in a band of an uplink BWP or an uplink carrier, and a downlink frequency domain resource or a flexible frequency domain resource located in at least part of a target area in the band of the uplink BWP or the uplink carrier,
wherein the target area is an area other than the edge in the band.

15. The terminal according to claim 14, wherein a guard gap is arranged between every two of the downlink frequency domain resource, the uplink frequency domain resource, and the flexible frequency domain resource.

16. The terminal according to claim 14, wherein a frequency domain resource supporting flexible duplexing is configured as the flexible frequency domain resource.

17. The terminal according to claim 14, wherein the locations of the frequency domain resources further comprise at least one of the following:
the downlink frequency domain resource configured with a Control Resource Set (CORESET), or
the flexible frequency domain resource configured with a CORESET when the flexible frequency domain resource is used as the downlink frequency domain resource.

18. The terminal according to claim 14, wherein the determining locations of frequency domain resources further comprises:
determining a location of the uplink frequency domain resource or the downlink frequency domain resource or the flexible frequency domain resource in a half-duplexing pattern.

19. The terminal according to claim 14, further comprising:
stopping, by the terminal, using the flexible frequency domain resource as the uplink frequency domain resource when the flexible frequency domain resource satisfies a predetermined condition,
wherein the predetermined condition comprises:
the flexible frequency domain resource comprises a Synchronization Signal Block (SSB) or CORESRT 0.
